(19) United States
(12) Patent Application Publication
(10) Pub. No.: US 2026/0210647 A1
(43) Pub. Date: Jul. 23, 2026

(54) Thermal Radiator With Selective Long Wave Infrared Emitter

(71) Applicant: The Regents of the University of California, Oakland, CA (US)

(72) Inventors: Jyotirmoy Mandal, Princeton, NJ (US); Aaswath Pattabhi Raman, Los Angeles, CA (US)

(73) Assignee: The Regents of the University of California, Oakland, CA (US)

(21) Appl. No.: 19/444,003

(22) Filed: Jan. 8, 2026

Related U.S. Application Data
(63) Continuation of application No. 17/755,307, filed on Oct. 29, 2020, now abandoned.
(60) Provisional application No. 62/927,596, filed on Oct. 29, 2019.

(51) Int. Cl. F28F 13/18; B60H 1/22; E06B 9/24; F28F 13/00

(52) U.S. Cl. CPC F28F 13/18; B60H 1/22; E06B 9/24; B60H 2001/2293; F28F 2013/001; F28F 2245/06

(57) ABSTRACT

Systems and methods for thermal radiators utilizing selective long-wave infrared emitters and materials therefore are provided. The thermal radiators and provided materials are configured for emittance in various spectrum ranges including within the 8-13 μm atmospheric window. The provided selective long-wave infrared emitters can be disposed on various surfaces such as vertical and horizontal building surfaces, walls and roofs, for thermoregulation with limited exposure to the sky and the surrounding environments. Designs and methods for fabricating and integrating the provided materials and emitters into various structures are also described.

### CROSS-REFERENCE TO RELATED APPLICATIONS

The current application is a continuation of U.S. patent application Ser. No. 17/755,307, entitled “Systems and Methods for Spectrally Selective Thermal Radiators with Partial Exposures to Both the Sky and the Terrestrial Environment”, filed Apr. 26, 2022 and published as US 2022-0381524 A1 on Dec. 1, 2022, which is a national stage of PCT Application No. PCT/US2020/057986 entitled “Systems and Methods for Spectrally Selective Thermal Radiators with Partial Exposures to Both the Sky and the Terrestrial Environment”, filed Oct. 29, 2020 and published as WO 2021/087128 A1 on May 6, 2021, which claims the benefit of and priority under 35 U.S.C. § 119 (e) to U.S. Provisional Patent Application No. 62/927,596 entitled “Spectrally Selective Thermal Radiators” filed Oct. 29, 2019, the disclosures of which are incorporated herein by reference in their entireties for all purposes.

### FIELD OF THE INVENTION

The present invention generally relates to spectrally selective thermal radiators, their methods of manufactures and applications thereof.

### BACKGROUND

Passive radiative cooling (PRC) is a process where objects under the sky radiate heat into outer-space through the long wavelength infrared (LWIR, 8-13 μm wavelength) transparency window of the atmosphere. Because it is a passive process, with a net cooling effect, this is a promising way to cool buildings and outdoor structures, and a sustainable alternative to air-conditioners, which are expensive, consume energy, release greenhouses gases and have a net heating effect on the environment.

### BRIEF SUMMARY

Methods and systems in accordance with various embodiments of the invention enable horizontally and vertically oriented selective thermal radiators, which are exposed to the cold sky as well as radiation from warm terrestrial features in view. Many embodiments provide passive radiative cooling in the long-wave infrared (LWIR) wavelengths on horizontal and vertical surfaces. Several embodiments implement selective LWIR emissive materials to optimize radiative heat flows on horizontal and vertical surfaces by enabling LWIR heat loss to the sky and reflectively filtering out the non-LWIR broadband heat from terrestrial features. Certain embodiments focus on passive radiative cooling in LWIR wavelengths on vertical surfaces. A number of embodiments demonstrate that vertically oriented selective LWIR emitters exhibit at least 0.4° C. cooler temperatures than broadband thermal emitters under warm weather. Several embodiments implement selective LWIR emitters on vertical surfaces to reduce heat loss in cold weather. Some embodiments exhibit that selective LWIR emitters can improve heating by at least 0.6° C. in cold weather. Examples of selective LWIR emitters include (but not limited to): plastic, polymer resin and inorganic dielectrics. Some embodiments enhance energy efficiency by replacing broadband emissive building materials with selectively LWIR emissive designs. Many embodiments implement radiative cooling designs including (but not limited to) metallized plastic, paint resin, and inorganic dielectrics. Several embodiments implement selective LWIR emitters on vertical facades of a building, roofs of a building, water cooling panels, IR reflective (low emittance, or low-E) glasses. Some embodiments implement selective LWIR emitters in thermal environment around human beings, including (but not limited to) selective LWIR textiles. A number of embodiments integrate selective LWIR emitters with phase-change-materials to amplify the thermoregulation capability.

One embodiment of the invention includes a selective long wave infrared (LWIR) emitter comprising an average emittance greater than 0.7 in long-wave infrared (LWIR) wavelengths, where the LWIR wavelengths range between about 8 μm and about 13 μm, and an average reflectance greater than 0.6 in a first wavelength range between about 2.5 μm and about 8 μm, and in a second wavelength range between about 13 μm and about 30 μm; where the selective LWIR emitter is placed on at least one surface of an object and oriented to have at least a partial view of the sky and a partial view of a terrestrial feature.

In a further embodiment, the selective LWIR emitter achieves radiative cooling and thermoregulation by radiative heat loss skywards into outer space in the LWIR wavelengths or by radiative heat gain from a terrestrial environment in the LWIR wavelengths; by reflective filtering thermal radiation outside the LWIR wavelengths; and by blocking of broadband radiative heat gain or loss to a terrestrial environment and the atmosphere outside the LWIR wavelengths.

In another embodiment, the selective LWIR emitter exploits the atmosphere's narrowband optical transmittance to thermal radiation in the LWIR wavelengths between a terrestrial object and the sky, and exploits the atmosphere's broadband transmittance to thermal radiation between an object and surrounding terrestrial features.

In a still further embodiment, the selective LWIR emitter is vertically oriented.

In still another embodiment, the selective LWIR emitter has better cooling efficiency in warm weather and better heating efficiency in cold weather than a broadband thermal emitter.

In yet another embodiment, the selective LWIR emitter is cooler than a broadband thermal emitter in warm weather.

In a yet further embodiment, the selective LWIR emitter is warmer than a broadband thermal emitter in cold weather.

In a yet further embodiment again, the selective LWIR emitter is a plastic, a polymer resin, or an inorganic dielectric material.

In another embodiment, the selective LWIR emitter is poly(4-methyl-1-pentene), poly(vinyl fluoride), polypropene, biaxially oriented poly(ethene terephthalate), a thin film of silicon dioxide, a thin film of silicon monoxide, a thin film of silicon nitride, a thin film of paint resin based on poly(methyl methacrylate), a thin film of paint resin based on poly(dimethylsiloxane) (PDMS), or any of the combinations thereof.

In a further embodiment, the selective LWIR emitter is placed on a layer of metal with a solar reflectance greater than 0.85.

In yet another embodiment, the metal is aluminum or silver.

In another additional embodiment, the selective LWIR emitter is placed on a transparent infrared reflective material, a thin metal film, or a transparent conducting oxide material.

In a yet further embodiment, the reflective material is a low-E glass.

In yet another embodiment, the transparent conducting oxide material is indium tin oxide.

In a still further embodiment, the selective LWIR emitter has a white, a silvery, a transparent or a semi-translucent appearance.

In a yet further embodiment again, the selective LWIR emitter further comprises an antioxidant or an IR-transparent UV absorber for protection against solar ultraviolet light.

In another embodiment, the antioxidant is Tris(2,4-di-tert-butylphenyl)phosphite.

In still another embodiment, the IR-transparent UV absorber is zinc oxide.

In a yet further embodiment, the selective LWIR emitter is a textile.

In a still further embodiment, the textile is a polypropene fabric or a poly(4-methyl-1-pentene) fabric.

In yet another embodiment, the textile is placed on a heat-reflective textile.

In another additional embodiment, the heat-reflective textile is aluminized rayon.

In a further embodiment, the at least one surface of the object is a wall, a roof, a window, a water-cooling panel, or an infrared reflective glass.

In a yet further embodiment, the at least one surface is a window or a transparent façade of the object.

In a still further embodiment, the object is a building or a vehicle.

Still another additional embodiment includes a passive radiative structure comprising a body, where at least one surface of the body is a selective long-wave infrared (LWIR) emitter, where the emitter has an average emittance greater than 0.7 in long-wave infrared (LWIR) wavelengths, where the LWIR wavelengths range between about 8 μm and about 13 μm; and an average reflectance greater than 0.6 in a first wavelength range between about 2.5 μm and about 8 μm, and in a second wavelength range between about 13 μm and about 30 μm.

In a further embodiment, the selective LWIR emitter achieves radiative cooling and thermoregulation by radiative heat loss skywards into outer space in the LWIR wavelengths or by radiative heat gain from a terrestrial environment in the LWIR wavelengths; by reflective filtering thermal radiation outside the LWIR wavelengths; and by blocking of broadband radiative heat gain or loss to a terrestrial environment and the atmosphere outside the LWIR wavelengths.

In an additional embodiment, the selective LWIR emitter exploits the atmosphere's narrowband optical transmittance to thermal radiation in the LWIR wavelengths between a terrestrial object and the sky, and exploits the atmosphere's broadband transmittance to thermal radiation between an object and surrounding terrestrial features.

In a still further embodiment, the structure has better cooling efficiency in warm weather and better heating efficiency in cold weather than a structure with a broadband thermal emitter.

In yet another embodiment, the structure is oriented such that part of its field of view is subtended by terrestrial features.

In another embodiment, the selective LWIR emitter is a plastic, a polymer resin or an inorganic dielectric material.

In still yet another embodiment, the selective LWIR emitter is poly(4-methyl-1-pentene), poly(vinyl fluoride), metalized polypropene, biaxially oriented poly(ethene terephthalate), a thin film of silicon dioxide, a thin film of silicon monoxide, a thin film of silicon nitride, a thin film of paint resin based on poly(methyl methacrylate), a thin film of paint resin based on poly(dimethylsiloxane) (PDMS), or any of the combinations thereof.

In a further embodiment again, the selective LWIR emitter is placed on a layer of metal with a solar reflectance greater than 0.85.

In still another embodiment, the metal is aluminum or silver.

In a further additional embodiment, the selective LWIR emitter is placed on a transparent infrared reflective material, a thin metal film, or a transparent conducting oxide material.

In a still further embodiment, the reflective material is a low-E glass.

In yet another embodiment, the transparent conducting oxide material is indium tin oxide.

In a further additional embodiment, the selective LWIR emitter has a white, a silvery, a transparent or a semi-translucent appearance.

In a still further embodiment, the selective LWIR emitter further comprises an antioxidant or an IR-transparent UV absorber for protection against solar ultraviolet light.

In a yet further embodiment, the antioxidant is Tris(2,4-di-tert-butylphenyl)phosphite.

In a still further embodiment, the IR-transparent UV absorber is zinc oxide.

In a yet another embodiment, the structure is a building, a vehicle, a textile, a water-cooling panel, or an infrared reflective glass.

In a further additional embodiment, the passive radiative structure further comprising a phase change material.

Another further embodiment again includes a method of passive radiative cooling and thermoregulation of a terrestrial object comprising, applying a selective long-wave infrared (LWIR) emitter onto at least one surface of the object having at least a partial view of the sky and a partial view of the terrestrial environment; where the emitter has an average emittance greater than 0.7 in long-wave infrared (LWIR) wavelengths, wherein the LWIR wavelengths range between about 8 μm and about 13 μm; and an average reflectance greater than 0.6 in a first wavelength range between about 2.5 μm and about 8 μm, and in a second wavelength range between about 13 μm and about 30 μm.

In a still further embodiment, the selective LWIR emitter achieves radiative cooling and thermoregulation by radiative heat loss skywards into outer space in the LWIR wavelengths or by radiative heat gain from a terrestrial environment in the LWIR wavelengths; by reflective filtering thermal radiation outside the LWIR wavelengths; and by blocking of broadband radiative heat gain or loss to a terrestrial environment and the atmosphere outside the LWIR wavelengths.

In a yet further embodiment, the selective LWIR emitter exploits the atmosphere's narrowband optical transmittance to thermal radiation in the LWIR wavelengths between a terrestrial object and the sky, and exploits the atmosphere's broadband transmittance to thermal radiation between an object and surrounding terrestrial features.

In yet another embodiment, the at least one surface of the object is vertically oriented.

In a further embodiment again, the object with the selective LWIR emitter has better cooling efficiency in warm weather and better heating efficiency in cold weather than a broadband thermal emitter.

In another embodiment again, the selective LWIR emitter is a plastic, a polymer resin, or an inorganic dielectric material.

In still another embodiment, the selective LWIR emitter is poly(4-methyl-1-pentene), poly(vinyl fluoride), polypropene, biaxially oriented poly(ethene terephthalate), a thin film of silicon dioxide, a thin film of silicon monoxide, a thin film of silicon nitride, a thin film of paint resin based on poly(methyl methacrylate), a thin film of paint resin based on poly(dimethylsiloxane) (PDMS), or any of the combinations thereof.

In yet another embodiment, the selective LWIR emitter is placed on a layer of metal with a solar reflectance greater than 0.85.

In a further embodiment, the metal is aluminum or silver.

In still a further embodiment again, the selective LWIR emitter is placed on a transparent infrared reflective material, a thin metal film, or a transparent conducting oxide material.

In yet another embodiment, the reflective material is a low-E glass.

In a still yet further embodiment, the transparent conducting oxide material is indium tin oxide.

In a further yet embodiment, the selective LWIR emitter has a white, a silvery, a transparent or a semi-translucent appearance.

In a still further embodiment, the selective LWIR emitter further comprises an antioxidant or an IR-transparent UV absorber for protection against solar ultraviolet light.

In yet another embodiment, the antioxidant is Tris(2,4-di-tert-butylphenyl)phosphite.

In still yet another embodiment, the IR-transparent UV absorber is zinc oxide.

In a still further embodiment, the at least one surface of the object is a wall, a roof, a window, a water-cooling panel, or an infrared reflective glass.

In a yet further embodiment, the at least one surface is a window or a transparent façade of the object.

In yet another embodiment, the object is a building or a vehicle.

Still another additional embodiment includes a method to reduce energy consumption of a building comprising, applying a selective long-wave infrared (LWIR) emitter onto at least one surface of the building having at least a partial view of the sky and a partial view of the terrestrial environment; where the emitter has an average emittance greater than 0.7 in long-wave infrared (LWIR) wavelengths, wherein the LWIR wavelengths range between about 8 μm and about 13 μm; and an average reflectance greater than 0.6 in a first wavelength range between about 2.5 μm and about 8 μm, and in a second wavelength range between about 13 μm and about 30 μm.

In a still further embodiment, the selective LWIR emitter achieves radiative cooling and thermoregulation by radiative heat loss skywards into outer space in the LWIR wavelengths or by radiative heat gain from a terrestrial environment in the LWIR wavelengths; by reflective filtering thermal radiation outside the LWIR wavelengths; and by blocking of broadband radiative heat gain or loss to a terrestrial environment and the atmosphere outside the LWIR wavelengths.

In a yet another embodiment, the selective LWIR emitter exploits the atmosphere's narrowband optical transmittance to thermal radiation in the LWIR wavelengths between a terrestrial object and the sky and exploits the atmosphere's broadband transmittance to thermal radiation between an object and surrounding terrestrial features.

In a yet still further embodiment, the at least one surface of the building is vertically oriented.

In a still yet further embodiment, the building with the selective LWIR emitter has better cooling efficiency in warm weather and better heating efficiency in cold weather than a broadband thermal emitter.

In still another embodiment again, the selective LWIR emitter is a plastic, a polymer resin, or an inorganic dielectric material.

In a still further embodiment, the selective LWIR emitter is poly(4-methyl-1-pentene), poly(vinyl fluoride), polypropene, biaxially oriented poly(ethene terephthalate), a thin film of silicon dioxide, a thin film of silicon monoxide, a thin film of silicon nitride, a thin film of paint resin based on poly(methyl methacrylate), a thin film of paint resin based on poly(dimethylsiloxane) (PDMS), or any of the combinations thereof.

In a yet further embodiment, the selective LWIR emitter is placed on a layer of metal with a solar reflectance greater than 0.85.

In a further embodiment, the metal is aluminum or silver.

In yet another embodiment, the selective LWIR emitter is placed on a transparent infrared reflective material, a thin metal film, or a transparent conducting oxide material.

In another embodiment, the reflective material is a low-E glass.

In still another embodiment again, the transparent conducting oxide material is indium tin oxide.

In another additional embodiment, the selective LWIR emitter has a white, a silvery, a transparent or a semi-translucent appearance.

In a still further embodiment, the selective LWIR emitter further comprises an antioxidant or an IR-transparent UV absorber for protection against solar ultraviolet light.

In a further yet embodiment, the antioxidant is Tris(2,4-di-tert-butylphenyl)phosphite.

In a still yet further embodiment, the IR-transparent UV absorber is zinc oxide.

In still another embodiment again, the at least one surface of the building is a wall, a roof, a window, a water-cooling panel, or an infrared reflective glass.

In yet another embodiment, the at least one surface is a window or a transparent façade of the object.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1 illustrates panoramic LWIR thermographs of locations representing rural and urban locations in different climate zones from the vantage point of a vertical wall with an embodiment of the invention.

FIG. 2 illustrates a schematic of possible radiative heat transfer between a vertical wall and the ground and sky in its view in accordance with an embodiment of the invention.

FIG. 3 illustrates radiance from a perfect broadband emitter and irradiances from the ground and the sky in accordance s an embodiment of the invention.

FIG. 4A illustrates spectral hemispherical emittance of a tropical and a desert atmosphere in accordance with an embodiment of the invention.

FIG. 4B illustrates spectral hemispherical transmittance of a tropical and a desert atmosphere in accordance with an embodiment of the invention.

FIG. 5 illustrates pyrgeometric measurements conditions in accordance with an embodiment of the invention.

FIGS. 6A and 6B illustrate heat gain from the ground and heat loss to the sky for an ideal broadband emitter and an ideal selective LWIR emitter in accordance with an embodiment of the invention.

FIGS. 7A and 7B illustrate differences between cooling potential and steady state temperature of an ideal selective LWIR emitter and broadband emitter in accordance with an embodiment of the invention.

FIG. 8 illustrates a schematic of experimental demonstration of the thermoregulation capability of selective LWIR emitters in accordance with an embodiment of the invention.

FIG. 9 illustrates spectral emittances of thick poly(4-methyl-1-pentene) and poly(vinylidene fluoride) in accordance with an embodiment of the invention.

FIGS. 10A and 10B illustrate solar irradiance, thermal irradiance, effective radiative temperature along the horizontal direction, ambient air temperature, and temperatures of the PMP selective emitter and PVdF broadband emitter in accordance with an embodiment of the invention.

FIGS. 11A-11C illustrate selective LWIR emitters in different varieties in accordance with an embodiment of the invention.

FIG. 12 illustrates the LWIR selectivity of different materials characterized by selectivity in accordance with an embodiment of the invention.

FIG. 13 illustrates potential modes of application of selective emitters in accordance with an embodiment of the invention.

FIG. 14 illustrates peak summer and wintertime energy savings enabled by a selective LWIR emitter in desert and tropical locations for wall materials with different U-values in accordance with an embodiment of the invention.

FIGS. 15A-15F illustrate cooling power of selective LWIR emissive textiles in accordance with an embodiment of the invention.

FIG. 16 illustrates a schematic of a selectively LWIR emissive fabric that can be made from aluminized rayon and polypropene or poly(4-methyl-1-pentene) fibers in accordance with an embodiment of the invention.

FIG. 17 illustrates a schematic of a vertical wall with equal views of the ground and sky in accordance with an embodiment of the invention.

FIG. 18 illustrates spectral emittances of an ideal broadband emitter and an ideal selective emitter used for calculating the cooling powers and steady state temperatures in accordance with an embodiment of the invention.

FIGS. 19A-19F illustrate cooling powers of an ideal broadband emitter, an ideal selective emitter and their differences for a desert climate, and corresponding values for a tropical climate in accordance with an embodiment of the invention.

FIGS. 20A-20F illustrate steady state temperature of an ideal broadband emitter, an ideal selective emitter and their differences for a desert climate, and corresponding values for a tropical climate in accordance with an embodiment of the invention.

FIGS. 21A-21F illustrate cooling powers of PMP and PVdF, and their differences for a desert climate, and corresponding values for a tropical climate in accordance with an embodiment of the invention.

FIGS. 22A-22F illustrate steady state temperature of PMP and PVdF, and their differences for a desert climate, and corresponding values for a tropical climate in accordance with an embodiment of the invention.

FIG. 23 illustrates radiation profiles of the ground, the sky, and an ideal broadband emitter held at the ambient temperature for hot summer days and cold winter nights in accordance with an embodiment of the invention.

FIG. 24 illustrates a schematic of a building for which radiative heat transfer through the walls is considered in accordance with an embodiment of the invention.

### DETAILED DESCRIPTION

Turning now to the drawings, radiative cooling and thermoregulation by horizontally and vertically selective thermal radiators in accordance with various embodiments are illustrated. Many embodiments describe passive radiative cooling by integrating selective long-wavelength infrared (LWIR) emitters. Radiative cooling can involve the radiation of terrestrial heat through the LWIR (λ~8-13 μm) atmospheric transmission window into outer space. Differential transmittance of the atmosphere can enable narrowband (LWIR) heat loss to the sky, and broadband heat gain from the terrestrial environment. Many embodiments include selective LWIR emitters on horizontal and/or vertical surfaces of a building. Several embodiments improve radiative cooling and thermoregulation by incorporating selective LWIR emitters on vertical surfaces of a building.

Many embodiments implement selective LWIR emitters on vertical building facades to enable higher cooling efficiency than conventional broadband thermal emitters. Several embodiments exhibit relative cooling of at least 0.4° C. in warm weather with selective LWIR emitters on vertical surfaces of a building. Some embodiments implement relative cooling between about 0.43° C. to about 0.46° C. in warm weather with selective LWIR emitters on vertical surfaces. Many embodiments implement selective LWIR emitters on vertical building facades to enable higher warming efficiency than conventional broadband thermal emitters in cold weather. Several embodiments exhibit the relative heating of at least 0.6° C. in cold weather with selective LWIR emitters on vertical surfaces of a building.

Many embodiments implement selective LWIR emitters including (but not limited to) polymers and inorganic dielectrics. Several embodiments utilize metallized plastics, paint resins, and inorganic dielectrics as selective LWIR emitters on vertical surfaces. Examples of selective LWIR emitters include (but are not limited to): poly(4-methyl-1-pentene) (PMP), poly(vinyl fluoride) (PVF), polypropene (PP), biaxially oriented poly(ethene terephthalate) (BoPET, also known as mylar), thin films of silicon dioxide, silicon monoxide or silicon nitride, thin films of paint resins based on poly(methyl methacrylate) (PMMA) and/or poly(dimethylsiloxane) (PDMS), and combinations thereof.

Some embodiments enhance energy efficiency by replacing broadband emissive building materials with selectively LWIR emissive designs. Several embodiments implement selective LWIR emitters on vertical facades of a building including (but not limited to) walls, windows, and roofs. Certain embodiments implement selective LWIR emitters on water cooling panels and low-E glasses. Some embodiments implement selective LWIR emitters in thermal environment around human beings, including (but not limited to) selective LWIR textiles. A number of embodiments integrate selective LWIR emitters with phase-change-materials to amplify the thermoregulation capability. Many embodiments demonstrate that in warm weather, selective LWIR emitters can achieve cooling savings between about 0.01 to about 0.04 kWh m⁻² day⁻¹ for walls depending on the insulation. Several embodiments show that in warm weather, selective LWIR emitters can achieve cooling savings between about 0.015 to about 0.065 kWh m⁻² day⁻¹ for windows depending on the glazing type. Some embodiments show that in warm weather, selective LWIR emitters can achieve cooling savings at least 0.06 kWh m⁻² day⁻¹ for metal sheets. Several embodiments show that in cold weather, selective LWIR emitters can achieve heating savings about 0 kWh m⁻² day⁻¹ for walls. Certain embodiments show that in cold weather, selective LWIR emitters can achieve heating savings between about 0 to about 0.005 kWh m⁻² day⁻¹ for windows. A number of embodiments show that in cold weather, selective LWIR emitters can achieve heating savings at least 0.012 kWh m⁻² day⁻¹ for metal sheets.

### Passive Radiative Cooling

With global increases in temperatures posing fundamental economic, health and security risks to human civilization, maintaining habitable built environments has become one of the most important challenges. Cooling and heating buildings can consume 12% of energy globally, with energy use for cooling in particular expected to grow dramatically. Prevalent cooling methods, such as air conditioners (ACs), move heat outside interior spaces, while consuming large amounts of electricity, generating their own heat, and resulting in direct and indirect greenhouse gas emissions. Furthermore, in urban areas, the net heat from dense clusters of AC units and the prevalence of human-made structures that trap solar heat and inhibit evaporative cooling, lead to heat islands that experience even hotter temperatures. Indeed, active cooling methods may exacerbate climate change and resulting cooling needs. Therefore, they may not be sustainable solutions for large-scale thermoregulation of built environments.

Controlling radiative heat flows into and out of buildings may be a central mechanism by which the need for active cooling and heating can be reduced. Research has explored a range of strategies for controlling solar heat gain through different components of the building envelope (e.g. roofs, walls, windows, and skylights). Innovations in materials synthesis and optical design have enabled tailored responses to different components of the solar spectrum (UV, visible and near-infrared wavelengths). However, in addition to solar gain, the built environment radiatively emits and absorbs heat from its immediate environment over infrared wavelengths (λ~2.5-40 μm). This ubiquitous heat exchange has, in large part, not been optimized and leveraged to enhance efficiency. One important exception has been the radiative cooling of sky-facing surfaces of buildings.

Radiative cooling can involve the radiation of terrestrial heat through the long-wavelength infrared (LWIR, λ~8-13 μm) atmospheric transmission window into outer space. Because the earth is at a higher temperature (~290 K) than outer space (~3 K), the radiative heat loss can be large if the surface radiating heat has a high emittance (E) in the LWIR wavelengths (ϵ_{LWIR}). If a surface has a sufficiently high solar reflectance it can also achieve a net heat loss and radiatively cool to sub-ambient temperatures under sunlight. Radiative cooling can be fundamentally passive in nature and yields a net cooling effect, making it a sustainable alternative to conventional active cooling systems. Research on radiative cooling has yielded a range of designs, ranging from traditional white paints, porous polymers, and silver-backed multilayer films, polymers, dielectric emitters and polymer-dielectric composites. These designs encompass both selective thermal emitters, which are optimal for achieving deep sub-ambient temperatures, and broadband thermal emitters which are suitable for operation at or near-ambient temperatures.

Passive radiative cooling involves a net radiative heat loss to the cold outer space through the atmospheric transmission window in the LWIR wavelengths. Due to its passive nature and net cooling effect, it is a promising alternative or complement to electrical cooling. For efficient radiative cooling an unimpeded view of the sky might be ideal, with prior work that focuses on roofs and flat surfaces facing the sky. However, the majority of the surface area of typical buildings are vertically oriented, with at least 50% of their field of view subtended by terrestrial features. Under sunlight, these features become warm and in turn thermally irradiate vertical façades of buildings. Since building facades are made of materials that are broadband emitters and absorbers of thermal radiation, this heating effect can dramatically counter heat loss to the sky, diminishing or even reversing the radiative cooling process.

While radiative cooling has been well-studied for horizontal, sky-facing surfaces, the majority of the surface area of a typical building's envelope may be vertically oriented. Many embodiments implement vertical surfaces (such as walls) in radiative cooling to the sky. Unlike horizontal surfaces, vertical surfaces have both the cold sky and the warm terrestrial environment in view. The thermal glow from terrestrial features can drastically reduce, and even reverse, radiative cooling in accordance with some embodiments. Several embodiments implement materials that can reduce heat gain from the terrestrial environment, while enabling heat loss to the cold sky for the radiative cooling of vertical surfaces.

Many embodiments implement scalable, selective LWIR emissive materials that can optimize radiative heat flows on vertical surfaces for energy savings. Several embodiments involve differential transmittance of the atmosphere towards the sky (narrowband, LWIR) and between terrestrial objects (broadband). Some embodiments implement selectively LWIR emitting radiative coolers to reflect large bandwidths of broadband thermal radiation from the earth, even as they radiate and lose LWIR heat into the sky. In many embodiments, selective LWIR emitters can yield greater cooling than radiative coolers with broadband thermal emittance. This can be significant for buildings, as traditional construction materials, white paints, and composites are broadband emitters. A number of embodiments demonstrate that vertically oriented selective LWIR emitters exposed to normal atmospheric convection can exhibit between about 0.43 to about 0.46° C. cooler temperatures than broadband thermal emitters when exposed to hot urban environments. In several embodiments, the enhanced cooling by selective LWIR emitters can diminish and/or reverse during the winter. Some embodiments implement a range of highly scalable radiative cooling designs, such as metallized plastics and paint resins and inorganic dielectrics that have the spectral characteristics to outperform conventional broadband emitters. Many embodiments demonstrate efficiency gains and lower summertime temperatures for vertical surfaces by replacing conventional broadband emissive building materials with selectively LWIR emissive designs.

Systems and methods for implementing radiative cooling using selective LWIR emitters in accordance with various embodiments of the invention are discussed further below.

### Radiative Cooling Mechanism

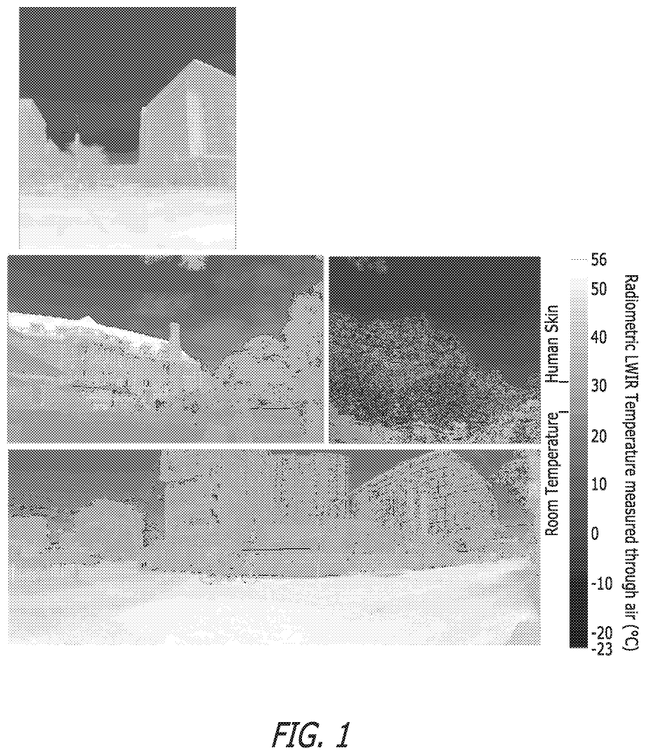

Research on radiative cooling may assume a scenario where a horizontal radiative cooler radiates heat under an unobstructed view of the sky. However, this assumption neglects a large fraction of the surface area for radiative heat transfer in buildings: the walls. Walls have at least half of their field of view subtended by terrestrial features. Roofs may have their view of the sky obstructed by taller buildings. An example of a panoramic thermograph of different landscapes and weathers across the world is illustrated in FIG. 1 in accordance with an embodiment of the invention. Panoramic LWIR thermographs of locations in Tempe and Sedona in the US, Oxford in the UK, and Chattogram in Bangladesh, representing rural and urban locations in different climate zones from the vantage point of a vertical wall. In all situations, the ground and other terrestrial features become warm during the day, while the sky, depending on the total precipitable water (TPW) in the atmosphere, exhibits varyingly cold LWIR temperatures. Terrestrial features can become strong radiators of heat in the daytime, warming objects like walls and humans in their view.

The presence of terrestrial objects in the field of view can have two effects. Firstly, it can reduce the spatial window for heat loss into the sky. Secondly, terrestrial objects themselves can radiate significant amounts of heat, especially when they reach high temperatures under sunlight (for example, temperatures higher than 60° C. for roads and pavements). Effectively this can replace the heat-sink of the sky with heat sources. The cooling power (P_{cooling}) of a vertical surface, defined as the difference between the thermal radiance from the surface (Iₑₘᵢₜₜₑᵣ) at ambient temperature and the downwelling atmospheric irradiance (I_{sky}), now takes the form:

$${P}_{c o o l i n g} = ( {I}_{emitter} - {vI}_{s k y} ) - ( 1 - v ) {I}_{earth} \qquad ( 1 )$$

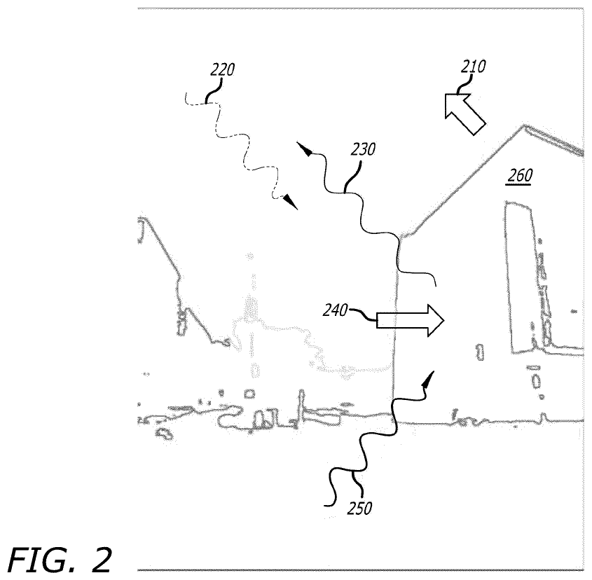

Iₑₐᵣₜₕ represents the ‘earth glow’ or radiance from the earth, and the view factor v is ≤0.5. An example of possible radiative heat transfer between a vertical wall and the ground and sky in its view is illustrated in FIG. 2 in accordance with an embodiment of the invention. In FIG. 2, the roof mainly sees the sky and loses heat (210). The radiated heat (Iₑₘᵢₜₜₑᵣ) is shown in 230. Atmospheric irradiance (I_{sky}) is shown in 220. The wall loses less, or even gains net heat (240). The radiance from the earth (Iₑₐᵣₜₕ) is shown in 250.

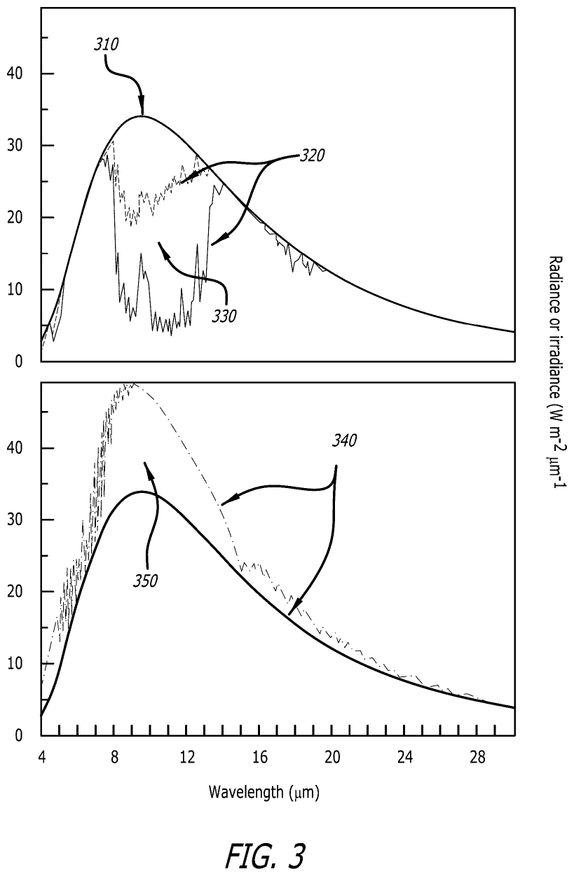

The problem is further compounded by the atmosphere, which is thick (at least 80 km) and appreciably transparent only in the LWIR wavelengths along skyward directions, but much thinner (around 101-102 μm) and transparent across the thermal spectrum between buildings and their environment. Consequently, while radiative heat loss to outer space occurs in the narrow LWIR band (λ~8-13 μm), radiative heat gains from terrestrial sources is broadband (λ~2.5-40 μm), which can be both inside and outside the LWIR band. An example of possible radiance from a broadband emitter and irradiance from the ground is illustrated in FIG. 3 in accordance with an embodiment of the invention. FIG. 3 illustrates that the possible radiance (Iₑₘᵢₜₜₑᵣ) (310) from a broadband emitter at the ambient temperature T_{amb}=32° C., and irradiances from the ground (Iₑₐᵣₜₕ) (340) at effective radiative temperature T_{ground}=55° C. and the sky (I_{sky}) (320) as seen through the atmosphere. Cases for two different humidity (TPW 10.5 and 58.6 mm) are shown. 330 shows the possible heat loss to the sky and 350 shows possible gain from the ground.

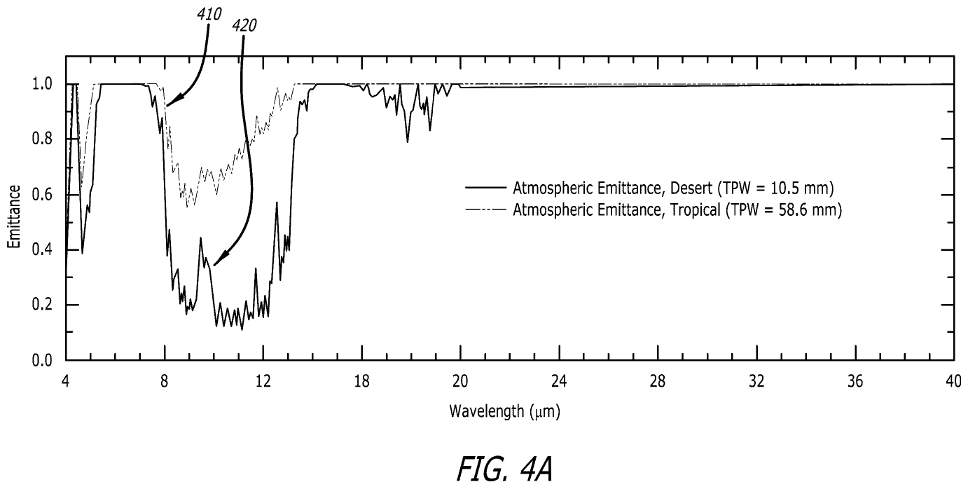

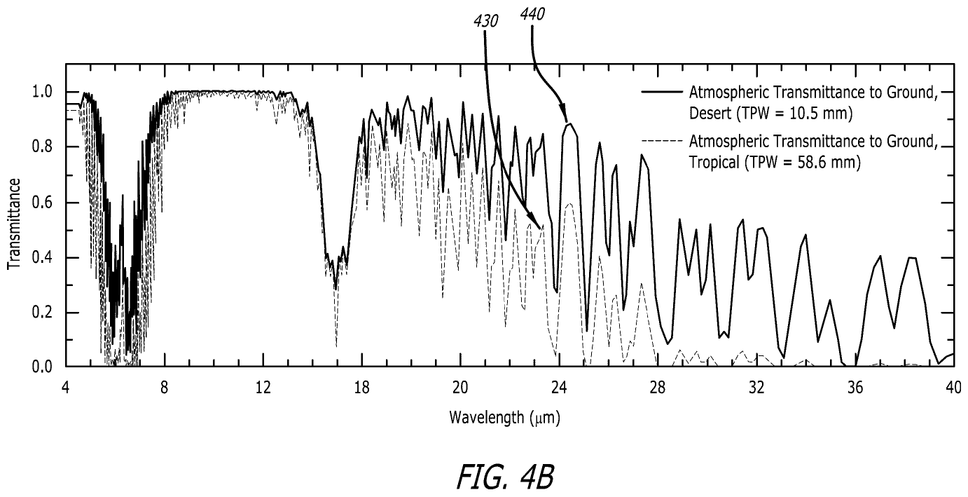

An example of hemispherical emittance and transmittance is illustrated in FIGS. 4A and 4B in accordance with an embodiment of the invention. FIG. 4A illustrates spectral hemispherical emittance of a tropical and a desert atmosphere as would be experienced by a perfect absorber at sea level. 410 shows atmospheric emittance of a tropical environment with TPW around 58.6 mm. 420 shows atmospheric emittance of a desert environment with TPW around 10.5 mm. FIG. 4B illustrates spectral hemispherical transmittance of the air between a point 10 m high on a vertical wall, and the ground which extends into the horizon. 430 shows atmospheric transmittance to ground of a tropical environment with TPW around 58.6 mm. 440 shows atmospheric transmittance to ground of a desert environment with TPW around 10.5 mm.

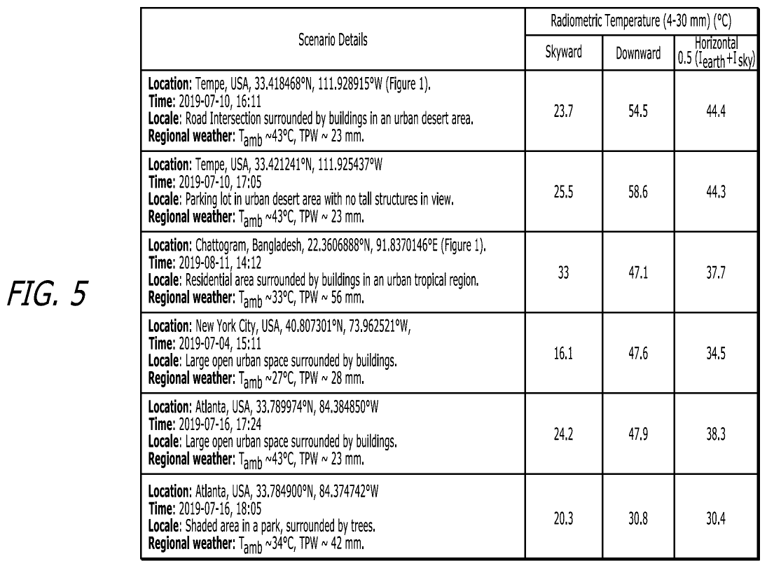

Many embodiments demonstrate that the effect of the factors on the cooling performance of broadband emissive radiative coolers that include building surfaces like traditional paint coatings, glass, bricks, and concrete can be significant. As shown in FIG. 3, since radiated heat scales as T⁴, even moderately above-ambient terrestrial heat sources can have a broadband heating potential that can counter or outweigh the LWIR cooling potential of the sky. This is also observed in horizonal pyrgeometric measurements of the thermal environment, which is hotter than the ambient air in warm locations. Given that walls and many urban roofs have terrestrial objects blocking their view of the sky, and that building envelopes are broadband thermal emitters/absorbers, heat radiated from terrestrial features can greatly reduce, or even reverse, radiative cooling. An example of pyrgeometric measurements of the environmental radiation and the effective radiative temperatures measured along the skyward, downward and horizontal directions for different locations is illustrated in FIG. 5 in accordance with an embodiment of the invention. Pyrgeometric measurements can account for thermal radiation over a broader range of wavelengths (5-30 μm) and offer a more complete account of thermal radiation from the environment than LWIR thermography, which is done over the 7.5-14 μm wavelengths. FIG. 5 shows that in scenarios without vegetation and tree cover, terrestrial environments, regardless of whether they are open or surrounded by tall structures that limit the view of the sky, become considerably warm during the day. Radiative temperatures measured by the pyrgeometer at horizontal orientations can be at or above the ambient air temperature, showing that LWIR heat loss to the sky is negated or overwhelmed by heat from terrestrial objects in view. FIG. 5 shows the need for selective LWIR emitters on vertical facades of buildings for cooling when it is warm.

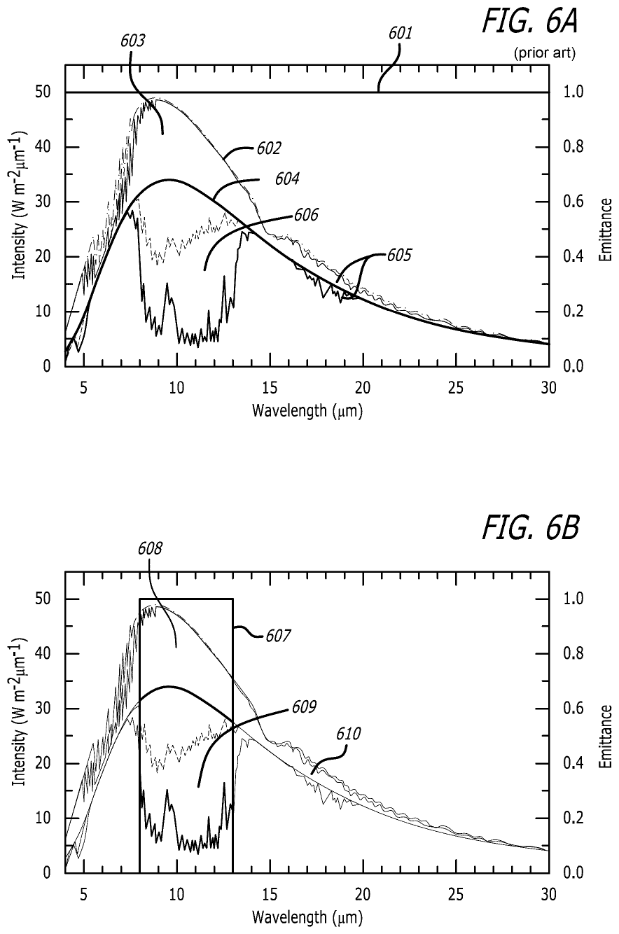

Many embodiments include that the differential transmittance of the atmosphere can enable narrowband (LWIR) heat loss to the sky, and broadband heat gain from the terrestrial environment. Several embodiments utilize radiative coolers which selectively emit and absorb radiation in the LWIR atmospheric window, and reflect other thermal wavelengths, to optimally harness the differential transmittance and enable improvements in the net heat flows into and out of buildings. Some embodiments use a vertical wall that has equal views of the cold sky and a hot ground under the sun to demonstrate the differences in a broadband emitter and a selective LWIR emitter. An example of heat gain and heat loss of a broadband emitter and a selective LWIR emitter is shown in FIGS. 6A and 6B in accordance with an embodiment. FIG. 6A illustrates a broadband emitter like a traditional paint absorbs and emits thermal radiation both within and outside the LWIR window. For a perfect broadband emitter (601), the radiative loss to the sky in the LWIR (606) can be negated or outweighed by the radiative gain from the ground (603), leading to heating. The possible heat gain (603) from the ground (at T_{ground}, here 55° C.) and heat loss (606) to the sky, as shown for an ideal broadband emitter (601) at ambient temperature T_{amb} (here 32° C.) under desert (TPW 10.5 mm) and tropical (TPW 58.6 mm) climates. The sum of the 603 and 606 areas represent the net cooling potential for the given T_{ground} and T_{amb}. Irradiances from the ground (Iₑₐᵣₜₕ) at T_{ground} is shown in 602. Irradiances from the sky (I_{sky}) at T_{amb} is shown in 605. Blackbody emission by emitter at T_{amb} is shown in 604. FIG. 6B illustrates that heat is only gained or lost in the LWIR window and reflected elsewhere for a selective LWIR emitter. By reflecting thermal radiation outside the window, the selective emitter can filter out much of the broadband thermal radiation from the ground, and enable greater cooling when the ground in view is hot. 607 shows an ideal selective LWIR emitter. 608 shows reduced heat gain. 609 shows heat loss. 610 shows broadband terrestrial heat outside the LWIR window is reflected, reducing heat gain and enhancing cooling. With a selective LWIR emitter, broadband heat gain can be minimized without reducing LWIR heat loss to space, resulting in cooling or significantly reduced heating compared to those achievable by broadband emissive radiative coolers.

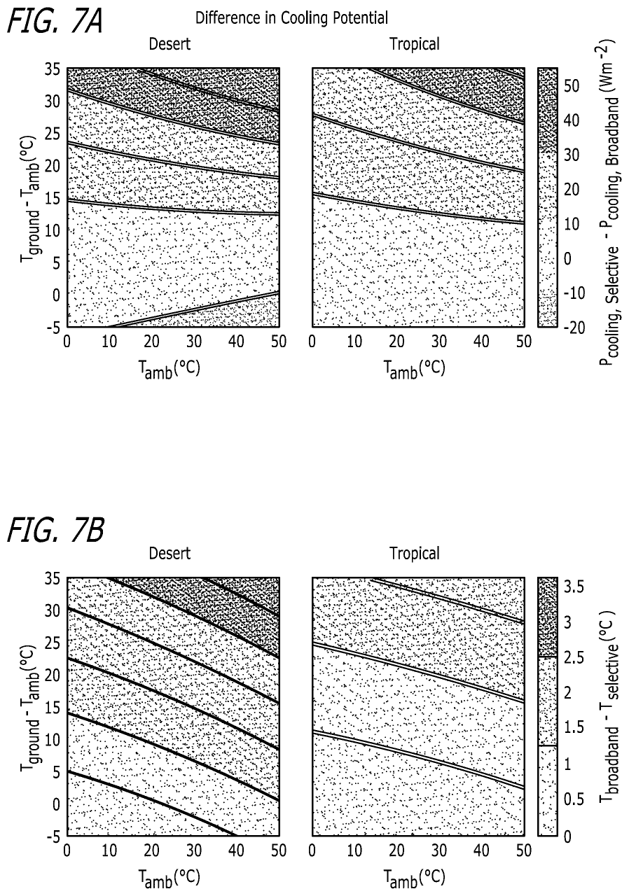

The cooling potential of a vertical surface (Eq. 1) may depend on a number of factors including (but not limited to) temperatures of the emitter (Tₑₘᵢₜₜₑᵣ), ambient air (T_{amb}) and ground (T_{ground}), meteorological variables, view factors of objects in the environment, and conductive and convective coefficients (h) of materials. Such factors can determine the Iₑₘᵢₜₜₑᵣ, I_{sky}, Iₑₐᵣₜₕ, and non-radiative heat flows. Calculations of theoretical cooling powers and steady state temperatures assuming negligible conductive heat flow show that a selective LWIR emitter can have considerable benefits. As shown in FIG. 7A, a selective LWIR emitter achieves a significantly greater P_{cooling} than a broadband emitter when T_{ground} is considerably greater than T_{amb}, as might occur on sunny summer days. In deserts, where lower total precipitable water levels enable greater LWIR heat loss into the sky, P_{cooling} can be higher by more than 50 Wm-2, which is comparable to P_{cooling} of cool roofs and would rise favorably for tall buildings with greater vertical surface areas. Conversely, when T_{ground}<T_{amb}, a selective emitter shows a lower P_{cooling}, which could prevent undesirable heat loss during winters or cold nights. A similar trend is seen in the differences in steady state temperatures (FIG. 7B). Under gentle winds (h~10 W m⁻² K⁻¹), a selective LWIR emitter stays ~3° C. cooler when the ground is hot, and at the same temperature as the broadband emitter when the ground is colder than the ambient air. The relative cooling during the summer, and the diminished cooling or even heating during the winter, suggests that the capabilities of selective LWIR emitters may go beyond radiative cooling in the summer to passive thermoregulation across seasons. Many embodiments demonstrate that a selective LWIR emitter could have greater cooling potentials during hot weather, and a relative heating potential during cold weather.

### Vertically Oriented Selective LWIR Emitters

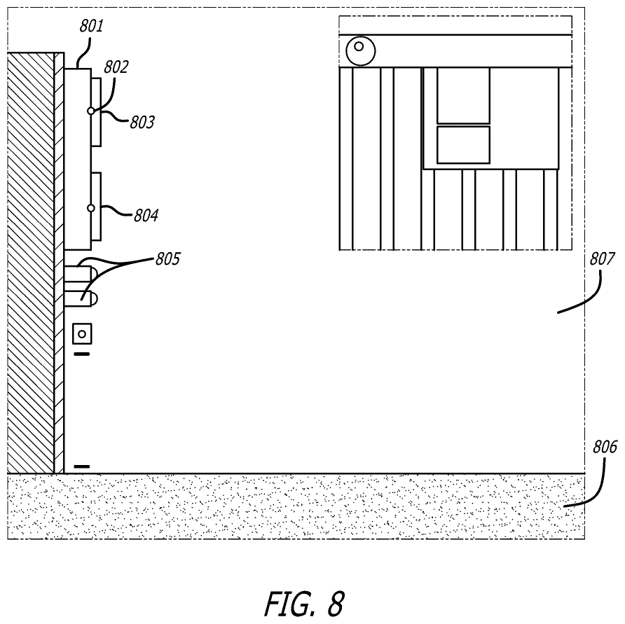

Several embodiments demonstrate vertically oriented selective thermal emitters have better cooling efficiency in summer and better heating efficiency in wintertime compared to broadband thermal emitters. An example of the thermoregulation capability of selective LWIR emitters is shown in FIG. 8 in accordance with an embodiment. 806 shows the Earth and 807 shows the cold sky. A Styrofoam (801) is on a vertical surface. A 508 μm thick silvered Poly(4-methyl-1-pentene) (PMP) sheet (804) is used as the selective emitter. A 125 μm thick silvered poly(vinyl fluoride) (PVdF) sheet (803) is used as the broadband emitter. A thermocouple (802) is placed between the Styrofoam and the selective emitter and the broadband emitter. Pyranometers (805) are also set up to monitor thermal radiation. The setup is at least 1 meter above the Earth. The setup in FIG. 8 is exposed to the environment, facing away from direct sunlight, in two locations, Los Angeles and Nashville. In Los Angeles, which represents summer weather, the environment is a parking lot in a semi-urban area, and the duration of exposure is about 40 minutes. In Nashville, which represents winter weather, the environment is an uphill view of a meadow and the duration of exposure is about 1 hour. Since both samples are silvered and have similarly high solar reflectance (about 0.92 for PMP and about 0.95 for PVDF), differential absorption of the indirect sunlight was small (<3 Wm-2), making thermal irradiances the dominant radiative mode of heat transfer.

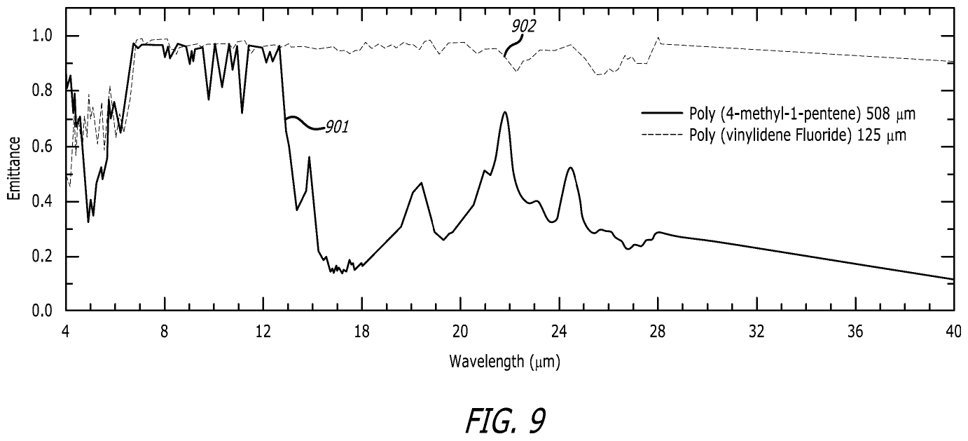

FIG. 9 illustrates spectral emittances of PMP and PVdF in accordance with an embodiment of the invention. The spectral emittances of 508 μm thick poly(4-methyl-1-pentene), a selective emitter is shown in 901. A 127 μm thick poly(vinylidene fluoride), a broadband emitter is shown in 902. Both emitters have their back sides silvered. Data in the 30-40 μm wavelength range are approximations based on FTIR measurements which are noisy and quantitative.

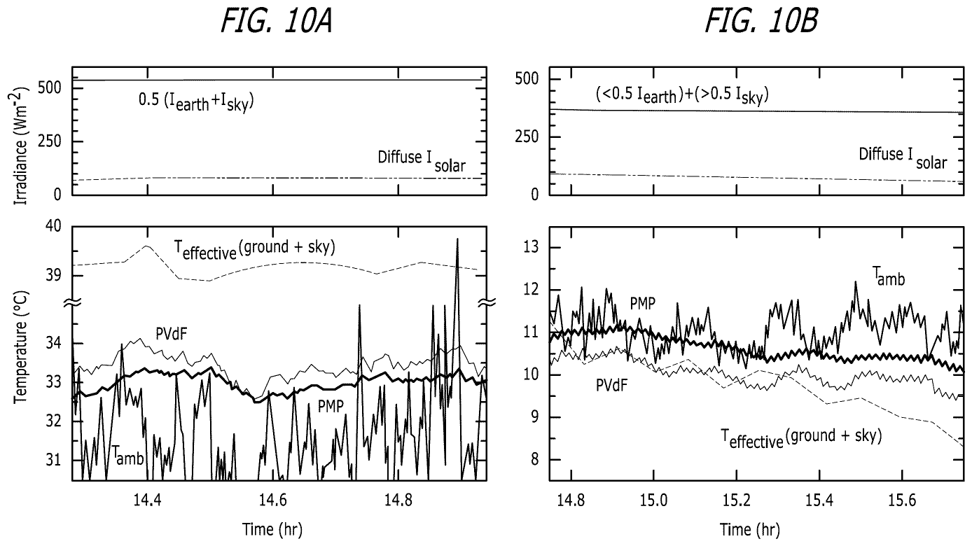

FIGS. 10A and 10B illustrate solar irradiance, thermal irradiance, effective radiative temperature (T_{effective}) along the horizontal direction, ambient air temperature (T_{amb}), and temperatures of the PMP selective emitter and PVdF broadband emitter in Los Angeles and Nashville in accordance with an embodiment of the invention. FIG. 10A shows Los Angeles, which represents a warm weather condition, the PMP selective emitter is 0.43° C. cooler on average over a 40-minute period than the PVdF broadband emitter. During intervals when windspeeds are lower, as much as 0.7° C. relative cooling is observed. A similar cooling by 0.46° C. is observed in another experiment conducted nearby at a different time. FIG. 10B shows Nashville, which represents a cold weather, the PMP is 0.6° C. warmer. Many embodiments indicate that selective emitters can enable cooling in warm weather and heating in cold weather relative to broadband emitters. Several embodiments show that selective LWIR emitters on vertical outdoor facades may enable greater cooling over broadband designs during the summer and reduce heat loss in the winter.

Many embodiments investigate a range of selective LWIR emitters, including plastics, polymer resins and inorganic dielectrics, for use on buildings. Examples of selective LWIR emitters include (but are not limited to): poly(4-methyl-1-pentene) (PMP or more commonly known as TPX®), poly(vinyl fluoride) (PVF), polypropene (PP), biaxially oriented poly(ethene terephthalate) (BoPET, commonly known as mylar), thin films of silicon dioxide, silicon monoxide or silicon nitride, and thin films of common paint resins based on poly(methyl methacrylate) (PMMA) and poly(dimethylsiloxane) (PDMS), and composite materials such as scotch-tape. In some embodiments, silicon dioxide, silicon monoxide or silicon nitride on an IR-reflective metal or transparent oxide layer. In some embodiments, a thin film of silicon dioxide, silicon monoxide and/or silicon nitride can be backed with metal to exhibit a selective LWIR emittance. Some embodiments include combination of LWIR selective materials as emitters. In certain embodiments, the combination of infrared transparent and solar reflective porous polyethene (PE) can be hot-pressed onto silver variants to make them white without affecting the selective IR-emittance. This can be useful in situations where specular or semi-specular solar reflection from silvered emitters can be harmful to human eyes.

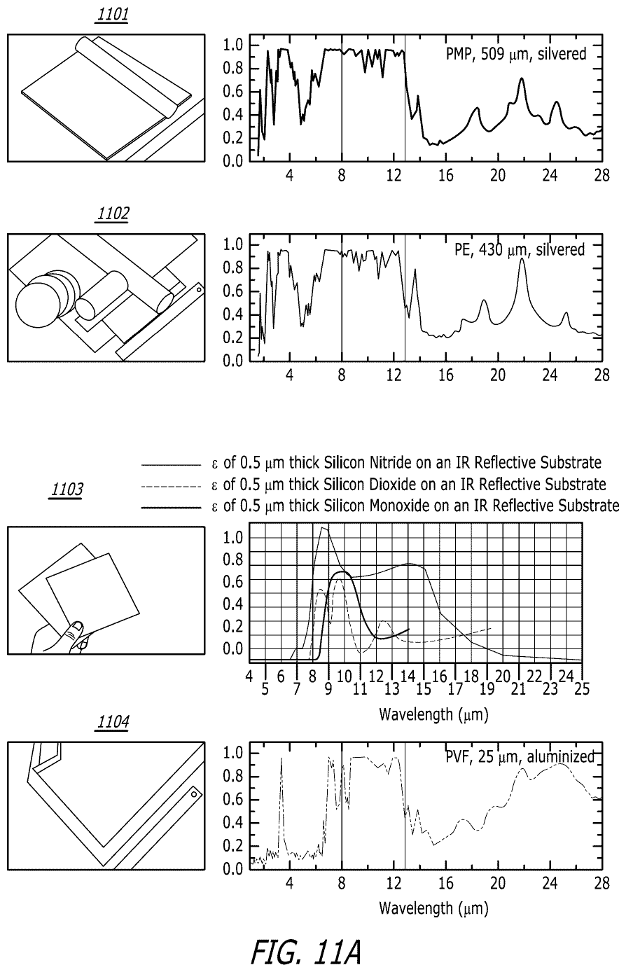

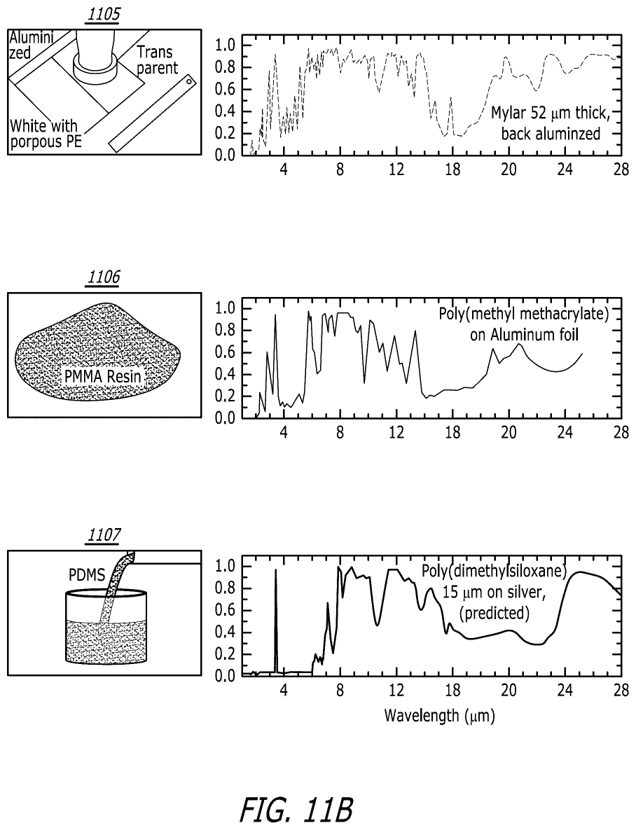

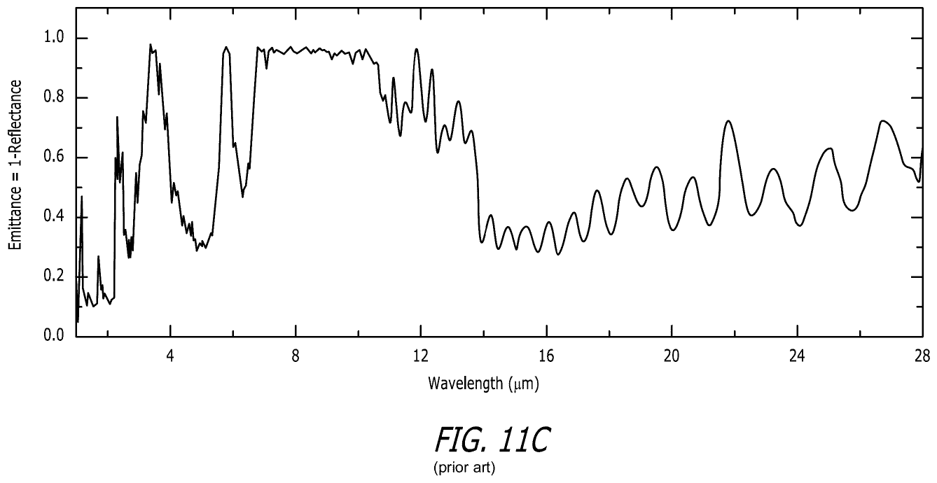

An example of selective LWIR emitters is illustrated in FIGS. 11A-11C in accordance with an embodiment. in FIG. 11A, 1101 illustrates poly(4-methyl-1-pentene) (PMP), which is a polyolefin polymer. PMP has a selective LWIR emittance when coupled with metal backreflectors. PMP can be known as TPX®. PMP is compatible with conventional polymer processing techniques and can be formed into films, sheets, non-woven membranes and fibers. Variants of PMP can be either transparent or white. Its chemical inertness makes it suitable for outdoor use, which has seen its usage in large scale broadband radiative cooling designs.

1102 illustrates polypropene (PP), which is a polyolefin polymer. The polymer is compatible with typical processing techniques, and can be formed into films, sheets, porous membranes, and textiles. Variants of polypropene can be made either transparent or white. While chemically inert, the presence of tertiary carbon atoms that are attacked by oxygen under UV light makes polypropene susceptible to sunlight. However, addition of small amounts of antioxidants such as Tris(2,4-di-tert-butylphenyl)phosphite or IR-transparent UV absorbers such as zinc oxide, can overcome the issue of UV susceptibility. With UV stabilizers added, polypropene can be used as reflective covers for building facades. Given its selective LWIR emissivity upon metallization, and its scale of manufacture, polypropene could be an attractive material for radiative thermoregulation of vertical building facades. Metallized polypropene can be sourced from plastic waste, such as crisp packets.

1103 illustrates the selective emittance of thin films of silicon dioxide, silicon monoxide and silicon nitride on metal. Due to their phonon resonances, these materials can exhibit strong selective emittance in one or more region of the LWIR wavelength range. When placed on metal in a single layer or multilayers, they can exhibit a strong, selective LWIR emittance and a specular solar reflectance. In some embodiments, the silicon dioxide, silicon monoxide and silicon nitride can be made into matte textures and/or powdered forms to exhibit diffuse white reflectance when backed with reflective metals, instead of specular, mirrorlike appearances. When placed on solar transparent and IR-reflective thin metal films, transparent conductive oxide films or low-E glass, thin films of silicon dioxide, silicon monoxide and silicon nitride can act as solar transparent selective LWIR emitters that reflect non-LWIR thermal radiation.

1104 illustrates poly(vinyl fluoride) (PVF), which is a fluoropolymer. PVF exhibits a selective LWIR emittance when coupled with metal backreflectors. Being a fluoropolymer, PVF is also highly non-absorptive in the solar wavelengths, and can be formed into white or transparent sheets. Commonly known as Tedlar®, PVF is known for its high durability and inertness, and is already used in building facades. PVF has high durability and is weather resistant, can be used in building faces and solar panels.

In FIG. 11B, 1105 illustrates Mylar (PET), which can be available in metalized sheets and fabric. Biaxially oriented poly(ethene terephthalate) (BoPET), known as mylar, and related variants (e.g. polyester) are moderately selective LWIR emitters, which are attractive because of their easy availability and compatibility with metals. PET is one of the most commonly used plastics, and used as containers for beverages and food. Aluminized mylar is used as sun-shields, solar reflectors, and in packaging. Transparent PET and related white variants (e.g. thin polyester paper) could be metallized to yield selective LWIR emittance. Mylar can be sourced from waste plastics.

1106 illustrates PMMA (acrylic). PMMA can be LWIR selective when being painted on metal as thin films. PMMA and variants have a range of uses, including as varnishes and polymer resins for outdoor paints. Although broadband emissive in large enough thicknesses, PMMA exhibits a modest LWIR selectivity when coated as thin films on metal. Given that the polymer is for outdoor use, PMMA can be practical for use on vertical facades. For use as selective emitters, variants of PMMA should contain little to no polymer functional groups that lead to absorptance/emittance outside the LWIR window.

1107 illustrates PDMS (silicone). PDMS can be LWIR selective when being painted on metal as thin films. PDMS/silicone variants are used as varnishes and polymer resins for outdoor paints. For use as selective emitters, variants of PDMS should contain little to no polymer functional groups that lead to absorptance/emittance outside the LWIR window.

FIG. 11C illustrates emittance of commercial scotch tape on metal. The emittance shows the scotch tape is selectively emissive in the LWIR. The selectivity metric ε_{LWIR}/ε_{non-LWIR} is about 1.59.

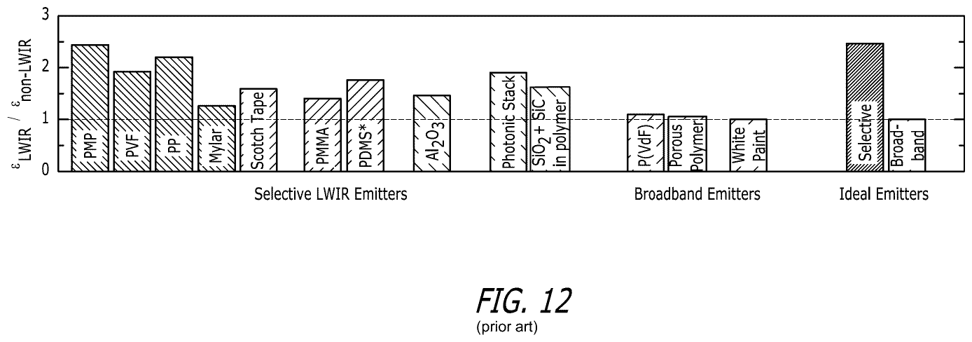

Several embodiments investigate emittance and selectivity of various selective LWIR emitter materials. The broadband, LWIR (λ~8-13 μm) and non-LWIR (λ~2.5-8 and 13-40 μm) ‘near-normal’ emittances of materials can be calculated by weighing their reflectance spectra measured at 15° angle of incidence against a blackbody at 25° C. Based on calculations using refractive indices of polymers, hemispherical emittances can be ~2% lower than the measured ‘near-normal’ emittance, and accordingly derived from the ‘near-normal’ emittances. The selectivity of the materials (ϵ_{LWIR}/ε_{non-LWIR}) can be calculated for various materials. An example of the LWIR selectivity of different materials, characterized as η=ϵ_{LWIR}/ϵ_{non LWIR} is illustrated in FIG. 12 in accordance with an embodiment.

Many embodiments implement selective LWIR emitters to be used in large scales. Some embodiments include that polypropene and mylar are common in their metallized forms to be sourced from plastic waste. Several embodiments include that these materials can come in white, silvered, and (in the case of transparent conducting oxide-backed polymers and Alumina) transparent variants. Several embodiments explore the use of selective LWIR emitters as building facades such as walls and windows. Possible modes of applications include silver or white ‘wallpapers’ (e.g. metallized PMP, PVF, PP, Mylar and their white polyethene coated variants and white tiles (e.g. films of sintered silicon dioxide, silicon monoxide or silicon nitride particles on metal, or combinations thereof), which could be deployed on walls. Metallic facades, which are intrinsically IR-reflective could have plastics laminated, or PDMS/PMMA painted onto them. A number of embodiments implement retroreflective variants of the reflective designs or transparent designs could be used.

### Application of Selective LWIR Emitters

In several embodiments, the thermoregulation capability of LWIR emitters on vertical building facades and the availability and variety of scalable LWIR emissive designs could lead to significant energy savings. Many embodiments use a quasi-steady state model that accounts for a fixed indoor temperature of 25° C. and vertical facades with different effective thermal conductance (U-Value accounting for thermal mass) to make estimates of building-level energy savings. Some embodiments show that during peak summer in the arid southwestern US or subtropical South Asia, selective LWIR emitters can achieve cooling savings of about 0.01-0.04 kWh m⁻² day⁻¹ for walls depending on the insulation, 0.015-0.065 kWh m⁻² day⁻¹ for windows depending on the glazing type, and >0.06 kWh m⁻² day⁻¹ for metal sheets. During winter, the heating savings are about 0 kWh m⁻² day⁻¹ for walls, about 0-0.005 kWh m⁻² day⁻¹ for windows and >0.012 kWh m⁻² day⁻¹ for metal sheets in the Southwestern US. For subtropical South Asia, heating penalties are observed, but depending on the U-value, they are about 2-10× lesser than summertime savings.

Many embodiments implement selective LWIR emitters to be used as energy-saving envelopes for a wide variety of vertical facades, and a complement to super-white roof coatings. Several embodiments include silvery or white LWIR emitters on brick or sheet-metal walls that offer thermoregulation capabilities with the benefits of high solar reflectance. Some embodiments include solar transparent LWIR emitters on low-E glasses, which are used in windows and steel-and-glass architectures. The low-E glass could have a thin film of metal as a solar-transparent, infrared-reflective layer, or transparent conducting oxides such as indium tin oxide.

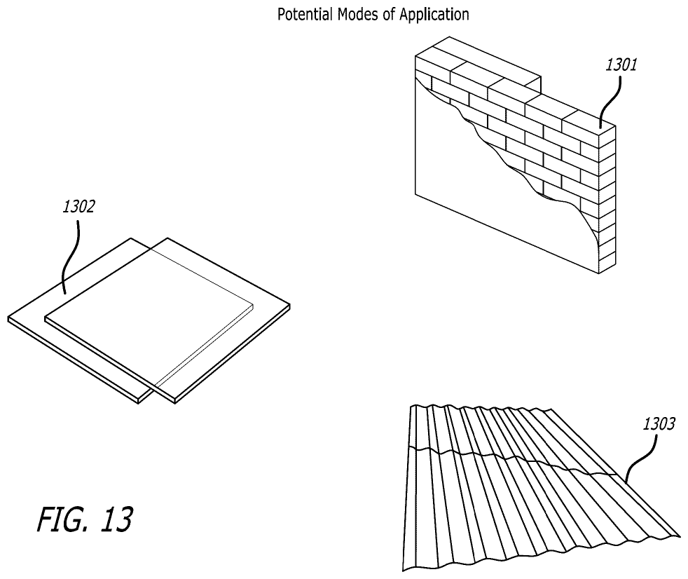

An example of potential modes of application of selective emitters onto vertical surfaces is illustrated in FIG. 13 in accordance with an embodiment. FIG. 13 illustrates potential ways in which selective LWIR emitters could be applied onto vertical facades made from materials with different U-values. 1301 shows white and/or silvery tiles, or wallpapers on brick walls which has U-values of about 0.5-2 W m⁻² K⁻¹. For brick, the U-value is an effective U-value that accounts for thermal mass. 1302 shows transparent selective emitters on low-E glass for windows and facades. Glass has U-values of about 1-5 W m⁻² K⁻¹. 1303 shows white and/or silvered emitters on flat or corrugated metal sheets. Metal sheets have U-values greater than 6 W m⁻² K⁻¹. For glass and metal, the thermal mass has minimal impact.

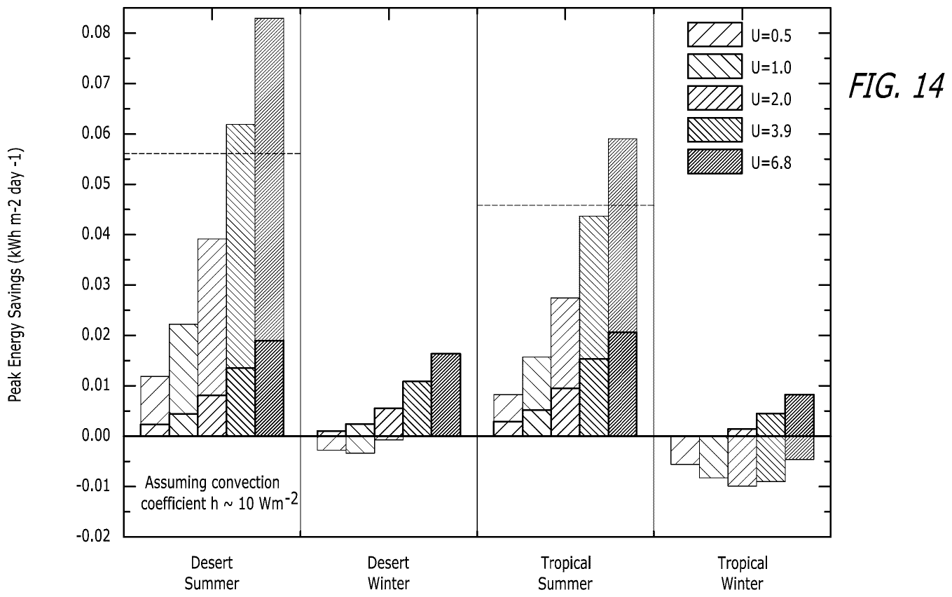

An example of peak summer and wintertime energy savings enabled by a selective LWIR emitter in desert and tropical locations for wall materials with different U-values is illustrated in FIG. 14 in accordance with an embodiment. A gentle wind corresponding to a convection coefficient of 10 W m⁻² K⁻¹ is assumed. Desert location corresponds to Palm Springs in the Southwestern US, while the tropical location corresponds to Kolkata in South Asia. The dotted lines indicating savings for white roofs on single-family houses during the summertime are derived from data for Phoenix (desert) and Miami (tropical).

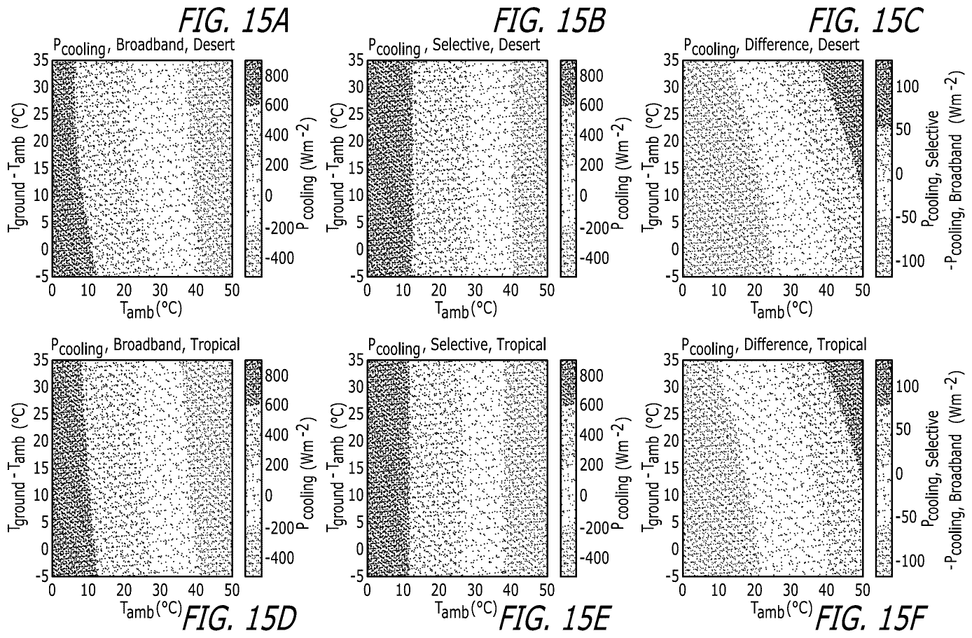

Some embodiments implement selective LWIR emitters in radiative cooling textiles. Textiles like broadband emissive cotton or IR-transparent polyethene (which exposes the broadband emissive skin underneath) can result in a net heat gain particularly in urban environments. Selectively LWIR emissive textiles, which could potentially be formed by metallizing PP based fabrics could offer a solution to this problem in accordance with some embodiments. Traditional textiles, which are broadband emitters rely mainly on non-radiative thermal processes for thermoregulation (e.g. insulation during the winter). Selective LWIR emissive textiles can have a better cooling effect in hot environments, and heating effect when it is cold as shown in several embodiments. Some embodiments calculate cooling powers of ideal broadband (close to traditional textiles, or a combination of thermally transparent variants and the broadband emissive skin) and ideal selective LWIR emitters with the emitters held at 33° C. to represent a comfortable skin temperature for humans. An example of cooling power of selective LWIR emissive textiles is illustrated in FIGS. 15A-15F in accordance with an embodiment. In some embodiments, a selectively LWIR emissive textiles can achieve relative cooling during hot weather and heating during cold weather. FIG. 15A shows cooling powers of an ideal broadband emitter at 33° C. FIG. 15B shows an ideal selective emitter 33° C. and FIG. 15C shows their differences for a desert climate, and FIGS. 15D-15F show corresponding values for a tropical climate. FIGS. 15C and 15F represent the relative cooling effects in the summer and warming effect in the winter selectively LWIR emissive textiles could have over broadband emitters.

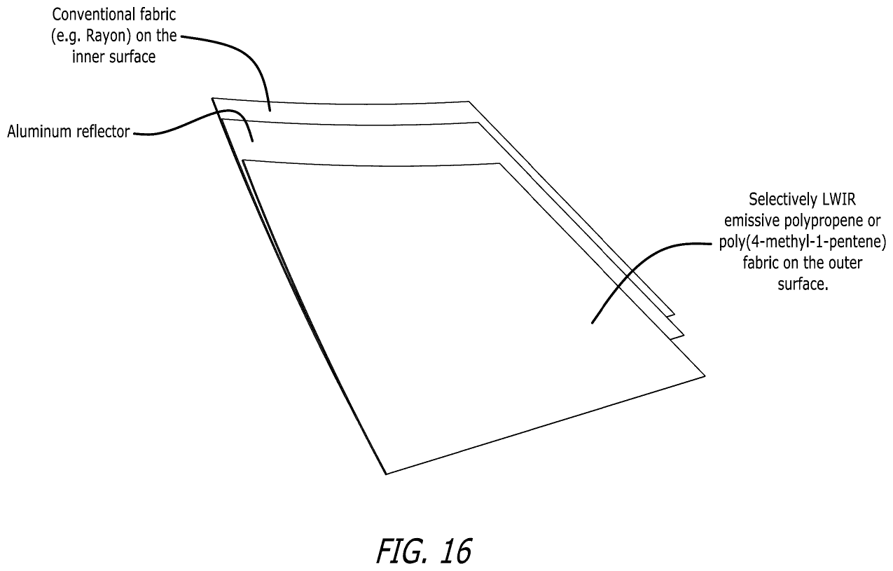

Many embodiments include that selectively LWIR emissive textiles could be made using polypropene fabrics or membranes as well as poly(4-methyl-1-pentene) variants. Using polymer processing techniques, such materials could be thermally bonded to LWIR emissive metallized plastics or be metallized themselves in accordance with some embodiments. Several embodiments address wearability of selective LWIR emissive textiles. In some embodiments, LWIR selective emitters could be bonded to the metallized side of commercially available heat-reflective textiles, such as aluminized rayon. An example of selective LWIR emissive textile design is shown in FIG. 16 in accordance with an embodiment of the invention. FIG. 16 illustrates a schematic of a selectively LWIR emissive fabric, which can be made from existing materials such as aluminized rayon and polypropene or poly(4-methyl-1-pentene) fibers.

Many embodiments demonstrate that selective LWIR emitters could be used on roofs and/or in water cooling panels in urban settings. Several embodiments include the use on building facades could be extended to vehicles. Certain embodiments integrate selective LWIR emitters with phase-change-materials, which could amplify the thermoregulation capability of LWIR emitters.

### Thermal Calculations

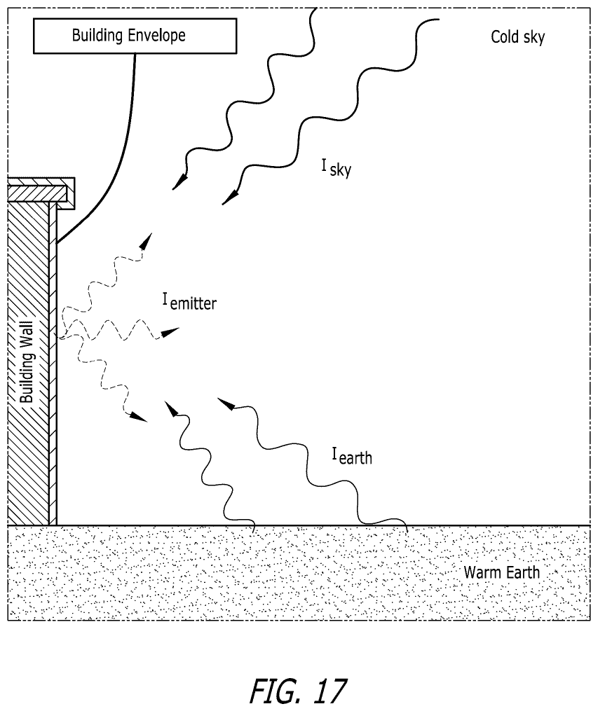

Modelling a vertical radiative cooler may need consideration of the sky and different terrestrial objects, their temperatures and view factors, and the partial cloaking of terrestrial radiation by the atmosphere. Many embodiments provide a case of a vertical wall with equal views of the ground and the sky, which can be extendable to more complicated cases. An example of the calculation model is provided in FIG. 17 in accordance with an embodiment. FIG. 17 illustrates a schematic of a vertical wall with equal views of the ground and sky. The three components determining the radiative heat gain or loss from the wall are shown.

Assuming that conduction into the building is negligible, and that solar absorption is negligible as well (reasonably so for highly reflective surfaces that only see diffuse sunlight in the sky), the heat transfer equation for the surface of the wall is as follows:

$${P}_{c o o l i n g} = {I}_{emitter} - 0.5 {I}_{s k y} - 0.5 {I}_{earth} - {Q}_{c o n v} \qquad ( 2 )$$

$$Where :$$

$${I}_{s k y} = {\int }_{2.5 μ m}^{∞ μ m} \overbrace{\int {ϵ}_{emitter} ( Ω , λ ) \cdot {ϵ}_{s k y} ( Ω , λ , TPW ) \cdot {I}_{B B} ( {T}_{amb} , λ ) d Ω}^{across field of view} d λ \qquad ( 3 )$$

$${I}_{earth} = {\int }_{2.5 μ m}^{∞ μ m} \overbrace{\begin{matrix}\int {ϵ}_{emitter} ( Ω , λ ) [ τ ( Ω , λ , {G}_{i} ) \cdot {I}_{B B} ( {T}_{g r o und} , λ ) + \\ ( 1 - τ ( Ω , λ , {G}_{i} ) ) \cdot {I}_{B B} ( {T}_{amb} , λ ) ] d Ω\end{matrix}}^{across field of view} d λ \qquad ( 4 )$$

$${I}_{emitter} = {\int }_{2.5 μ m}^{∞ μ m} \overbrace{\int {ϵ}_{emitter} ( Ω , λ ) \cdot {I}_{B B} ( {T}_{emitter} λ ) d Ω}^{across field of view} d λ \qquad ( 5 )$$

$${Q}_{c o n v} = h ( {T}_{a m b} - {T}_{emitter} ) \qquad ( 6 )$$

and ϵₑₘᵢₜₜₑᵣ is the emittance (selective or broadband) of the emitter on the wall, Esky IS the emittance of the sky when looking through the atmosphere above the horizon, t is the transmittance of the column of atmosphere between the emitter and the ground containing masses Gᵢ of i greenhouse gases (H₂O, O₃, CO₂, CH₄), IBB (T, λ) represents blackbody emissions at temperature T, T_{amb} is the ambient temperature, T_{ground} is the effective temperature of the ground assuming an emittance of 1, Tₑₘᵢₜₜₑᵣ is the temperature of the emitter, Q is the solid angle as viewed from the emitter, A is the wavelength, TPW is the total precipitable water in the atmosphere, G is the amount of greenhouse gases and h is the convection coefficient.

ϵ_{sky}, which is used to derive I_{sky}, is calculated for two different TPWs, 10.5 mm, representing a desert environment and 58.6 mm, representing a humid environment. The calculation of I_{ground} is more complicated, and involves calculating the t of different columns of air between the ground and a point on the wall at 10 m height, as a function of Ω. The hemispherical emittances and transmittances are shown in FIGS. 4A and 4B.

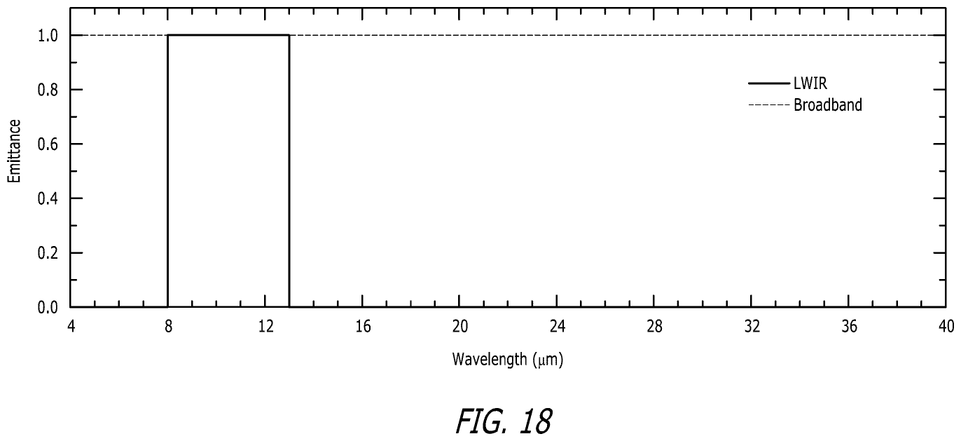

Equations 3-6 can be numerically calculated. By setting T_{amb}=Tₑₘᵢₜₜₑᵣ, the P_{cooling} values for ideal broadband and ideal selective LWIR emitters are obtained from Equation 2. Setting P_{cooling} to 0, on the other hand, yields the steady state temperatures for a given emittance. Likewise, the cooling power and steady state temperature differences for the poly(4-methyl-1-pentene) and poly(vinylidene fluoride) are also calculated. The spectral emittances of an ideal broadband emitter and an ideal selective emitter used for calculating the cooling powers and steady state temperatures is provided in FIG. 18.

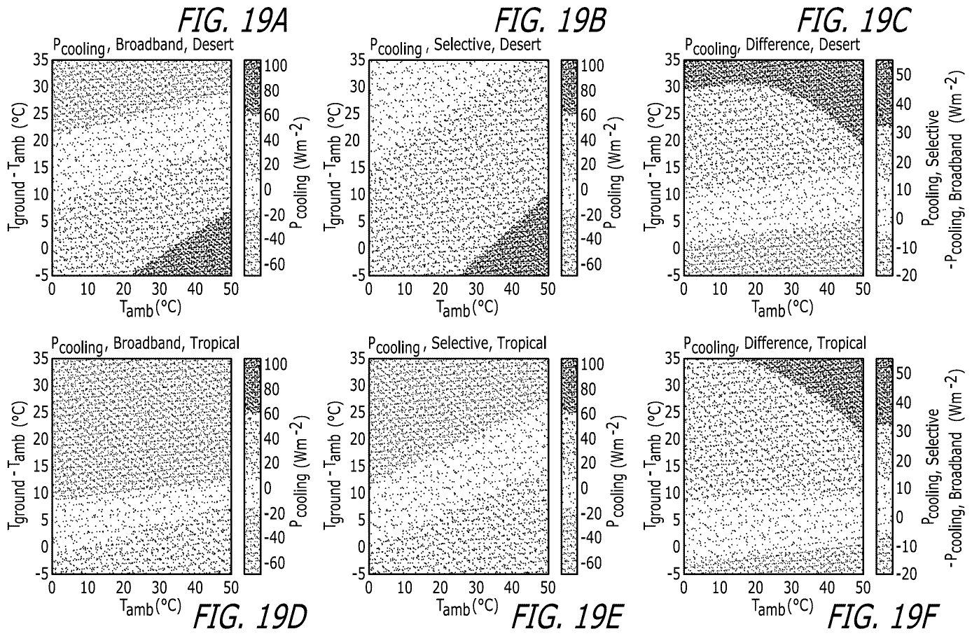

FIGS. 19A-19F illustrate cooling powers of an ideal broadband emitter (FIG. 19A), an ideal selective emitter (FIG. 19B) and their differences for a desert climate (FIG. 19C), and FIGS. 19D-19F provide corresponding values for a tropical climate. P_{cooling} is calculated for different ambient air temperatures representing cold to hot weather, and a range of ground temperatures relative to the air temperature. As evident from FIGS. 19C and 19F, the selective emitter has a relative cooling effect when the ground is warm relative to the ambient temperature, and a warming effect when the ground is cold.

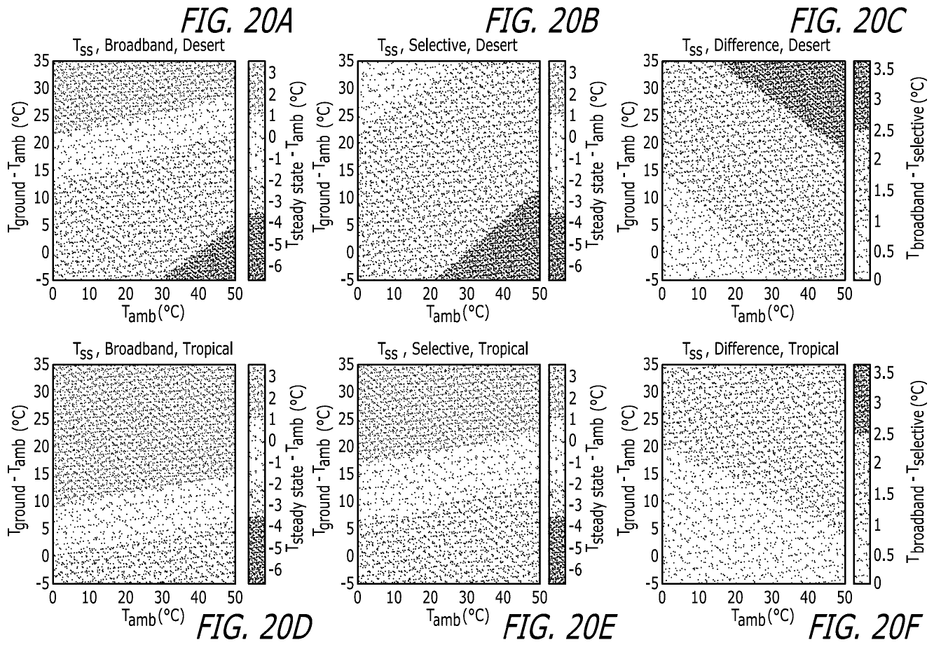

FIGS. 20A-20F illustrate steady state temperature of an ideal broadband emitter (FIG. 20A), an ideal selective emitter (FIG. 20B) and their differences for a desert climate (FIG. 20C), and FIGS. 20D-20F provide corresponding values for a tropical climate. Tₛₛ is calculated for different ambient air temperatures representing cold to hot weather, and a range of ground temperatures relative to the air temperature. As evident from FIGS. 20C and 20F, the selective emitter is cooler when the ground is warm relative to the ambient temperature, and at virtually same temperature as the broadband emitter when the ground is cold.

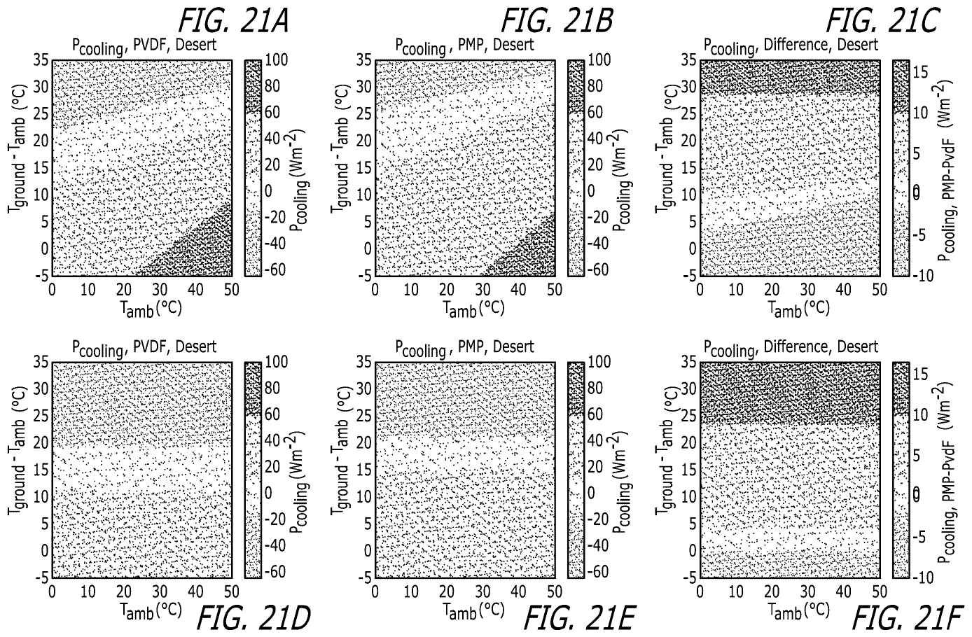

FIGS. 21A-21F illustrate cooling power of 508 μm thick PMP (FIG. 21A), 127 μm thick poly(vinylidene fluoride) (FIG. 21B) and their differences for a desert climate (FIG. 21C), and FIGS. 21D-21F provide corresponding values for a tropical climate. The differences in cooling powers is smaller since the PMP is not an ideal emitter and not at an optimized thickness that enhances cooler performance.

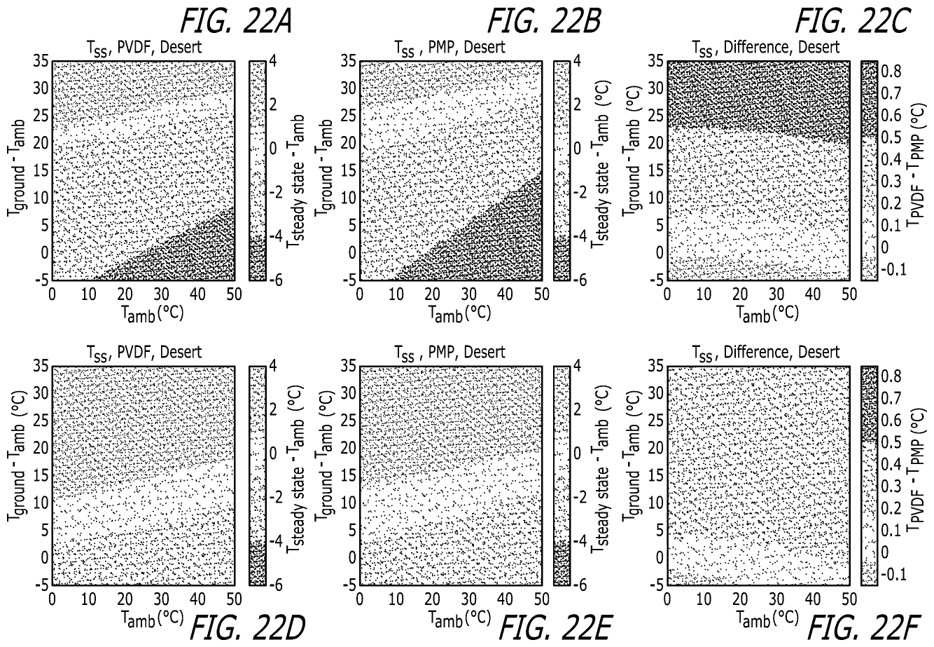

FIGS. 22A-22F illustrate steady state temperature of 508 μm thick PMP (FIG. 22A), 127 μm thick poly(vinylidene fluoride) (FIG. 22B) and their differences for a desert climate (FIG. 22C), and FIGS. 22D-22F provide corresponding values for a tropical climate. As for cooling power, the difference in steady state temperatures are smaller, compared to the ideal case.

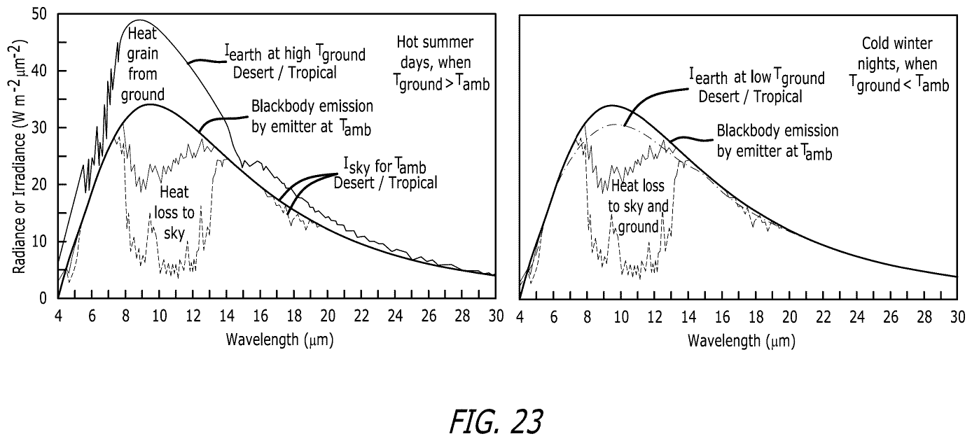

FIG. 23 shows the origin of the relative heating effect of the selective LWIR emitter for low T_{amb} and T_{ground}. As shown in FIG. 23, when the ground is colder than the ambient air, as it frequently gets at night due to radiative cooling, an emitter at ambient temperature loses heat to both the ground and the sky. In such a case, a selective LWIR emitter can cut down on any undesirable broadband heat loss to the ground, leading to a net heating effect.

### Energy Savings Models in Buildings

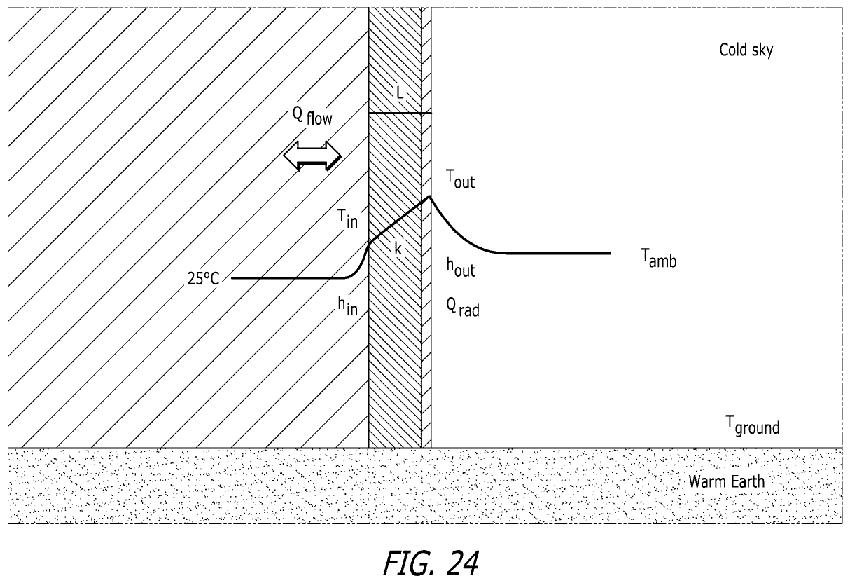

Many embodiments use a simplified case of an air-conditioned, cuboid-shaped building which can either have a traditional building envelope or a selective LWIR emissive building envelope. A cross section showing the indoor environment, the wall and the outdoors is shown in FIG. 24. For the model, the following conditions are used:
The building is maintained at an air temperature of 25° C. in all seasons.
Two scenarios with consistent total precipitable water (10.5 mm and 58.7 mm) in the atmosphere throughout the year, but with the temperature changing seasonally.
For such scenarios, there will be heat flow through the walls, roof and the ground floor, which is offset by the temperature control system. The contribution through the walls is considered. This is reasonable for cases where the roof and the ground floor are well-insulated, and for intermediate floors of multistoried buildings that are not in direct contact with the roof or the ground. The building walls are made of one material (e.g. all glass window, or all brick).

$$Brick wall ( U - value = \frac{Conductivity}{Wall Thickness} ∼ 2 W {m}^{- 2} {K}^{- 1}$$

for 25 cm thickness), concrete (U-value~3.9 W m⁻² K⁻¹ for 15 cm thickness) glass panes (U-value~1-5 W m⁻² K⁻¹ depending on the type of glazing), and sheet metal (U-value>5 W m⁻² K⁻¹).
An average wall height of ~10 m above the ground (for which radiation through the atmosphere from ground-contributing to Q_{rad} was modelled). This implies that the facades are large, and that contributions to heat flow by edges and corners are small. Thus a 1-D heat transfer model offers a reasonable approximation.
Given that Tᵢₙ is close to 25° C. (i.e. ΔT=Tᵢₙ−298 is small), radiative heat transfer coefficients between the walls and the air is small

$$σ ( {T}_{i n}^{4} - 29 {8}^{4} ) ∼ 4 σ ( 29 {8}^{3} ) Δ T ∼ 6 Δ T$$

to begin with. Furthermore, given the size of the building, the air is >90% transparent to thermal radiation, and the internal facades just see each other, drastically reducing radiative heat loss. The roof and the floors are well insulated and close to 25° C.
While this is a reasonable approximation for metal sheets and window panes, for a brick wall, which has a considerable thermal mass (~200 kg m⁻² for a 10 cm thick wall and a specific heat capacity ~800 J kg⁻¹ K⁻¹). However, as an approximation, the effect of the thermal mass can be factored into the effective thermal resistance (‘R-value’) or conductance (‘U-value’) of the wall material. Depending on the climate zone, thermally massive materials may have their ‘U-value’ effectively reduced by a factor of ~2. Given the thick brick and concrete walls, the effective U-value of those thus gets reduced to 1 W m⁻² K⁻¹. A value for modelling for U-values is 0.5-6.8 W m⁻² K⁻¹
First-order calculations show that for drastic differences in ground and wall temperatures (say 40° C.), the conductive heat flow (<1 W across a 1 m cross sectional width of the wall) along the height of the wall is ~10³ smaller compared to thermal irradiance (>100 W per m² of the wall), and 10² smaller than convection.

The convection coefficients on the inner and outer sides of the wall with thickness L are denoted as hᵢₙ~5 and hₒᵤₜ~10, both corresponding to mild winds, while the radiative heat transfer at the wall surface is denoted as Q_{rad}=Iₑₐᵣₜₕ+I_{sky}−Iₑₘᵢₜₜₑᵣ. In that case, the heat flow Q_{flow} per unit area of the wall can be approximated as:

$${Q}_{flow} = {h}_{i n} ( {T}_{i n} - 298 ) = \frac{k}{L} ( {T}_{out} - {T}_{i n} ) = {h}_{out} ( {T}_{a m b} - {T}_{out} ) + {Q}_{R a d} ( {T}_{out} , {T}_{amb} , {T}_{g r o u n d} , M ) \qquad ( 7 )$$

$$Now , {h}_{i n} ( {T}_{i n} - 298 ) = \frac{k}{L} ( {T}_{out} - {T}_{i n} ) {⟹}^{\begin{matrix}substitution \\ arithmatic\end{matrix}} \frac{k}{L} ( {T}_{out} - {T}_{i n} ) = \frac{{h}_{i n}}{A + 1} ( {T}_{out} - 2 \; 98 ) ,$$

$$where$$

$$A = \frac{{h}_{i n} L}{k} = \frac{{h}_{i n}}{U} , and U is the so called U - value the wall . Consequently :$$

$${Q}_{flow} = \frac{{h}_{i n}}{A + 1} ( {T}_{out} - 25 ) = {h}_{out} ( {T}_{a m b} - {T}_{out} ) + {Q}_{R a d} ( {T}_{out} , {T}_{a m b} , {T}_{g r o u n d} , M ) \qquad ( 8 )$$

The above equation can be numerically solved for Tₒᵤₜ, which can then be used to calculate Q_{flow}. Q_{flow} values can be calculated for selective and broadband emitters for ‘peak summer’ and ‘peak winter’ days in Palm Springs, which represents hot desert conditions in southwestern US, and Kolkata, which represents a subtropical South Asian climate.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A method of passive radiative cooling and thermoregulation of an object, comprising,
applying a selective long-wave infrared (LWIR) emitter onto at least one surface of the object having at least a partial view of the sky and a partial view of its terrestrial environment, wherein the at least one surface of the object is vertically oriented;
wherein the emitter has an average emittance greater than 0.7 in LWIR wavelengths range between 8 μm and 13 μm; and
wherein the emitter has an average emittance less than 0.4 in a first wavelength range between 2.5 μm and 8 μm, and in a second wavelength range between 13 μm and 30 μm.

2. The method of claim 1, wherein the selective LWIR emitter cools the object:
by radiative heat loss skywards into outer space or by radiative heat gain from the terrestrial environment in the LWIR wavelengths;
by reflective filtering thermal radiation outside the LWIR wavelengths; and
by blocking broadband radiative heat gain or loss to the terrestrial environment and the atmosphere outside the LWIR wavelengths.

3. The method of claim 1, wherein the selective LWIR emitter exploits the atmosphere's narrowband optical transmittance to thermal radiation in the LWIR wavelengths between the object and the sky, and exploits the atmosphere's broadband transmittance to thermal radiation between the object and surrounding terrestrial features.

4. The method of claim 1, wherein the object with the selective LWIR emitter has better cooling efficiency in warm weather and better heating efficiency in cold weather than a broadband thermal emitter.

5. The method of claim 1, wherein the selective LWIR emitter is a plastic, a polymer resin, or an inorganic dielectric material.

6. The method of claim 1, wherein the selective LWIR emitter is poly(4-methyl-1-pentene), poly(vinyl fluoride), polypropene, biaxially oriented poly(ethene terephthalate), a film of silicon dioxide, a film of silicon monoxide, a film of silicon nitride, a film of paint resin based on poly(methyl methacrylate), a film of paint resin on poly(dimethylsiloxane) (PDMS), or any of the combinations thereof.

7. The method of claim 6, further comprising placing the selective LWIR emitter on a layer of metal with a solar reflectance greater than 0.85.

8. The method of claim 7, wherein the metal is aluminum or silver.

9. The method of claim 6, further comprising placing the selective LWIR emitter on a transparent infrared reflective material, a metal film, or a transparent conducting oxide material.

10. The method of claim 9, wherein the transparent infrared reflective material is a low-E glass.

11. The method of claim 9, wherein the transparent conducting oxide material is indium tin oxide.

12. The method of claim 6, wherein the selective LWIR emitter has a white, a silvery, a transparent or a semi-translucent appearance.

13. The method of claim 1, further comprising adding an antioxidant or an IR-transparent UV absorber to the selective LWIR emitter.

14. The method of claim 13, wherein the antioxidant is Tris(2,4-di-tert-butylphenyl)phosphite.

15. The method of claim 13, wherein the IR-transparent UV absorber is zinc oxide.

16. The method of claim 1, wherein the at least one surface of the object is a wall, a roof, a window, a water-cooling panel, an infrared reflective glass, or a transparent façade of the object.

17. The method of claim 1, wherein the object is a building or a vehicle.
